(19) United States
(12) Patent Application Publication
(10) Pub. No.: US 2015/0087375 A1
(43) Pub. Date: Mar. 26, 2015

(54) SYSTEMS AND METHODS FOR PLAYER ALLOCATION

(71) Applicant: GAMESYS LTD, London (GB)

(72) Inventors: Robeson Mandela Reeves, London (GB); Phillip Jarlath Graham, London (GB); Darse Billings, London (GB)

(21) Appl. No.: 14/558,696

(22) Filed: Dec. 2, 2014

Related U.S. Application Data
(63) Continuation of application No. PCT/IB2014/059737, filed on Mar. 12, 2014.
(60) Provisional application No. 61/894,066, filed on Oct. 22, 2013.
(60) Provisional application No. 61/780,969, filed on Mar. 13, 2013.

(51) Int. Cl. G07F 17/32; A63F 13/30; A63F 1/00

(52) U.S. Cl. CPC G07F 17/323; A63F 1/00; A63F 13/30; G07F 17/3288; A63F 2001/005
USPC 463/13

(57) ABSTRACT

Systems, methods, and articles of manufacture provide for player allocation amongst game sessions such as based on game play style and/or aggressiveness metrics and/or based on desired entertainment-based attributes for one or more sessions.

### CROSS-REFERENCE TO RELATED APPLICATIONS

The present application claims benefit and priority to, and is a continuation of, International Patent Application No. PCT/IB2014/059737 filed on Mar. 13, 2014 and published as WO 2014/141133 on Sep. 18, 2014, which itself claims benefit and priority to: (i) U.S. Provisional Patent Application No. 61/894,066 filed on Oct. 22, 2013 and (ii) U.S. Provisional Patent Application No. 61/780,969 filed on Mar. 13, 2013.

### BACKGROUND

Gaming tournaments for various types of games such as online, offline, skill-based, games of chance, and games of mixed skill and chance are a continued source of entertainment to game players, and are often a source of great revenue for gaming companies. Accordingly, there is a desire to provide players with increasingly newer, more interesting, engaging, or entertaining games. There is also an ongoing desire to promote proper allocation of players in online environments.

### BRIEF DESCRIPTION OF THE DRAWINGS

An understanding of embodiments described herein and many of the attendant advantages thereof may be readily obtained by reference to the following detailed description when considered with the accompanying drawings, wherein:

FIG. 1 is a block diagram of a system according to some embodiments;

FIG. 2 is a block diagram of a system according to some embodiments;

FIG. 3 is a block diagram of a system according to some embodiments;

FIG. 4 is a block diagram of a system according to some embodiments;

FIG. 5 is a block diagram of a system according to some embodiments;

FIG. 6 is a block diagram of a system according to some embodiments;

FIG. 7 is a flow diagram of a method according to some embodiments;

FIG. 8 is a flow diagram of a method according to some embodiments;

FIG. 9 is a flow diagram of a method according to some embodiments

FIG. 10 is a block diagram of an apparatus according to some embodiments; and

FIG. 11A, FIG. 11B, FIG. 11C, FIG. 11D, and FIG. 11E are perspective diagrams of exemplary data storage devices according to some embodiments.

### DETAILED DESCRIPTION

Embodiments presented herein are descriptive of systems, apparatus, methods, and articles of manufacture for allocating players, such as to different instances of online games. In some embodiments, players are allocated based on game play style metrics and/or based on desired entertainment mixes for game instances. In some embodiments, game instances may be altered to cause and/or facilitate player allocation and/or reallocation.

Throughout the description that follows and unless otherwise specified, the following terms may include and/or encompass the example meanings provided in this section. These terms and illustrative example meanings are provided to clarify the language selected to describe embodiments both in the specification and in the appended claims, and accordingly, are not intended to be limiting. While not generally limiting and while not limiting for all described embodiments, in some embodiments, the terms are specifically limited to the example definitions and/or examples provided. Other terms are defined throughout the present description.

A “game”, as the term is used herein (unless specified otherwise), may generally comprise any game (e.g., wagering or non-wagering, electronically playable over a network) playable by one or more players in accordance with specified rules. A game may be playable on a Personal Computer (PC) online in web browsers, on a game console and/or on a mobile device such as a smart-phone or tablet computer. “Gaming” thus generally refers to play of a game.

A “casual game”, as the term is used herein (unless specified otherwise), may generally comprise (and in specific embodiments may be expressly limited to) a game with simple rules with little or no time commitment on the time of a player to play. A casual game may feature, for example, very simple game play such as a puzzle or Scrabble™ game, may allow for short bursts of play (e.g., during work breaks), an ability to quickly reach a final stage and/or continuous play without a need to save the game.

A “social network game”, as used herein (unless specified otherwise), generally refers to (and in specific embodiments may be expressly limited to) a type of online game that is played through a social network, and in some embodiments may feature multiplayer and asynchronous game play mechanics. A “social network” may refer to an online service, online community, platform, or site that focuses on facilitating the building of social networks or social relations among people. A social network service may, for example, consist of a representation of each user (often a profile), his/her social links, and a variety of additional services. A social network may be web-based and provide means for users to interact over the Internet, such as e-mail and instant messaging. A social network game may in some embodiments be implemented as a browser game, but can also be implemented on other platforms such as mobile devices.

A “wagering game”, as the term is used herein (unless specified otherwise), may generally comprise (and in specific embodiments may be expressly limited to) a game on which a player can risk a wager or other consideration, such as, but not limited to: slot games, poker games, blackjack, baccarat, craps, roulette, lottery, bingo, keno, casino war, etc. A wager may comprise a monetary wager in the form of an amount of currency or any other tangible or intangible article having some value which may be risked on an outcome of a wagering game. “Gambling” or “wagering” generally refers to play of a wagering game.

The term “game provider”, as used herein (unless specified otherwise), generally refers to (and in specific embodiments may be expressly limited to) an entity or system of components which provides games for play and facilitates play of such game by use of a network such as the Internet or a proprietary or closed networks (e.g., an intranet or wide area network). For example, a game provider may operate a website which provides games in a digital format over the Internet. In some embodiments in which a game comprising a wagering game is provided, a game provider may operate a gambling website over which wagers are accepted and results of wagering games are provided.

As utilized herein, the term “player” may generally refer to (and in specific embodiments may be expressly limited to) any type, quantity, and or manner of entity associated with the play of a game. In some embodiments, a player may comprise an entity conducting play of an online game, for example, may comprise an entity that desires to play a game (e.g., an entity registered and/or scheduled to play and/or an entity having expressed interest in the play of the game—e.g., a spectator) and/or may comprise an entity that configures, manages, and/or conducts a game. A player may be currently playing a game or have previously played the game, or may not yet have initiated play—i.e., a “player” may comprise a “potential player” (e.g., in general and/or with respect to a specific game). In some embodiments, a player may comprise a user of an interface (e.g., whether or not such a player participates in a game or seeks to participate in the game). In some embodiments, a player may comprise an individual (or group) that enters, joins, logs into, registers for, and/or otherwise access an online game room, session, server, and/or other particular instance and/or segmentation of an online game.

Some embodiments described herein are associated with a “player device” or a “network device”. As used herein, a “player device” is a subset of a “network device”. The “network device”, for example, may generally refer to any device that can communicate via a network, while the “player device” may comprise a network device that is owned and/or operated by or otherwise associated with a player. Examples of player and/or network devices may include, but are not limited to: a PC, a computer workstation, a computer server, a printer, a scanner, a facsimile machine, a copier, a Personal Digital Assistant (PDA), a storage device (e.g., a disk drive), a hub, a router, a switch, and a modem, a video game console, or a wireless or cellular telephone. Player and/or network devices may, in some embodiments, comprise one or more network components.

As used herein, the term “network component” may refer to a player or network device, or a component, piece, portion, or combination of player or network devices. Examples of network components may include a Static Random Access Memory (SRAM) device or module, a network processor, and a network communication path, connection, port, or cable.

In addition, some embodiments are associated with a “network” or a “communication network.” As used herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration or type that is or becomes known. Communication networks may include, for example, devices that communicate directly or indirectly, via a wired or wireless medium such as the Internet, intranet, a Local Area Network (LAN), a Wide Area Network (WAN), a cellular telephone network, a Bluetooth® network, a Near-Field Communication (NFC) network, a Radio Frequency (RF) network, a Virtual Private Network (VPN), Ethernet (or IEEE 802.3), Token Ring, or via any appropriate communications means or combination of communications means. Exemplary protocols include but are not limited to: Bluetooth™, Time Division Multiple Access (TDMA), Code Division Multiple Access (CDMA), Global System for Mobile communications (GSM), Enhanced Data rates for GSM Evolution (EDGE), General Packet Radio Service (GPRS), Wideband CDMA (WCDMA), Advanced Mobile Phone System (AMPS), Digital AMPS (D-AMPS), IEEE 802.11 (WI-FI), IEEE 802.3, SAP, the best of breed (BOB), and/or system to system (S2S).

As used herein, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard. Information may, according to some embodiments, be compressed, encoded, encrypted, and/or otherwise packaged or manipulated in accordance with any method that is or becomes known or practicable.

The term “indication”, as used herein (unless specified otherwise), may generally refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

A “session”, as the term is used herein (unless indicated otherwise), may generally comprise (and in specific embodiments may be expressly limited to) a period of time spanning a plurality of event instances or turns of the game, the session having a defined start and defined end. An event instance or turn is triggered upon an initiation of, or request for, at least one result of the game by a player, such as an actuation of a “start” or “spin” mechanism, which initiation causes an outcome to be determined or generated (e.g., a random number generator is contacted or communicated with to identify, generate or determine a random number to be used to determine a result for the event instance).

As used herein, the terms “outcome” and “result” should be differentiated in the present description in that an “outcome” is generally a representation of a “result”, typically comprising one or more game elements or game symbols. For example, in a “fruit themed” game, a winning outcome (i.e., an outcome corresponding to some kind of award, prize or payout) may comprise a combination of three “cherry” symbols. The “result” of this outcome may be a payout of X credits awarded to the player associated with the game. In another example, in a game in which a character moves along a game interface from a starting position to a finish position, an “outcome” of the game may comprise a symbol representing one or more movements along the interface and the “result” corresponding to this outcome may be the particular number and direction of the character's movement (e.g., three (3) spaces backwards such that the character ends up further away from the finish line). In a session embodiment, a session result may comprise a binary result (e.g., a player or game character wins or loses the session) and/or the particular award (or magnitude of award) won or earned by the player based on the session (e.g., the number of credits awarded to the player). It should be noted that the embodiments described herein encompass awards, prizes and payouts which are monetary, non-monetary, tangible or intangible.

As used herein, the term “virtual currency” may generally refer to an in-game currency that may be used as part of a game or one or more games provided by a game provider as (i) currency for making wagers, and/or (ii) to purchase or access various in-game items, features or powers.

A “credit balance”, as the term is used herein (unless indicated otherwise), may generally refer to (i) a balance of currency, whether virtual currency and/or real currency, usable for making wagers in a game and/or (ii) another tracking mechanism for tracking a player's success or advancement in a game by deducting there from points or value for unsuccessful attempts at advancement and adding thereto points or value for successful attempts at advancement.

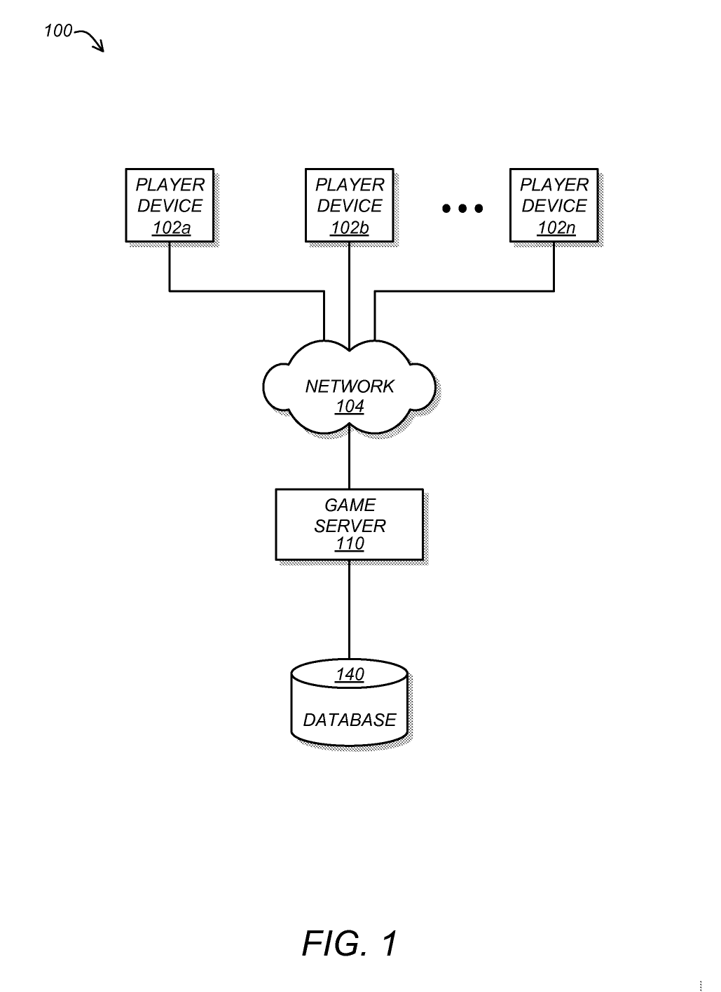

Turning first to FIG. 1, a block diagram of a system 100 according to some embodiments is shown. In some embodiments, the system 100 may comprise a gaming platform such as a gaming platform via which one or more multiplayer and/or online games may be played. In some embodiments, the system 100 may comprise a plurality of player devices 102a-n in communication with and/or via a network 104. In some embodiments, a game server 110 may be in communication with the network 104 and/or one or more of the player devices 102a-n. In some embodiments, the game server 110 (and/or the player devices 102a-n) may be in communication with a database 140. The database 140 may store, for example, game date (e.g., processed and/or defined by the game server 110), data associated with players (not explicitly shown) owning and/or operating the player devices 102a-n, and/or instructions that cause various devices (e.g., the game server 110 and/or the player devices 102a-n) to operate in accordance with embodiments described herein.

According to some embodiments, any or all of the components 102a-n, 104, 110, 140 of the system 100 may be similar in configuration and/or functionality to any similarly named and/or numbered components described herein. Fewer or more components 102a-n, 104, 110, 140 (and/or portions thereof) and/or various configurations of the components 102a-n, 104, 110, 140 may be included in the system 100 without deviating from the scope of embodiments described herein. While multiple instances of some components 102a-n are depicted and while single instances of other components 104, 110, 140 are depicted, for example, any component 102a-n, 104, 110, 140 depicted in the system 100 may comprise a single device, a combination of devices and/or components 102a-n, 104, 110, 140, and/or a plurality of devices, as is or becomes desirable and/or practicable. Similarly, in some embodiments, one or more of the various components 102a-n, 104, 110, 140 may not be needed and/or desired in the system 100.

The player devices 102a-n, in some embodiments, may comprise any type or configuration of electronic, mobile electronic, and or other network and/or communication devices (or combinations thereof) that are or become known or practicable. A first player device 102a may, for example, comprise one or more PC devices, computer workstations (e.g., game consoles and/or gaming computers), tablet computers, such as an iPad® manufactured by Apple®, Inc. of Cupertino, Calif., and/or cellular and/or wireless telephones such as an iPhone® (also manufactured by Apple®, Inc.) or an Optimus™ S smart phone manufactured by LG® Electronics, Inc. of San Diego, Calif., and running the Android® operating system from Google®, Inc. of Mountain View, Calif. In some embodiments, one or more of the player devices 102a-n may be specifically utilized and/or configured (e.g., via specially-programmed and/or stored instructions such as may define or comprise a software application) to communicate with the game server 110 (e.g., via the network 104).

The network 104 may, according to some embodiments, comprise a LAN, WAN, cellular telephone network, Bluetooth® network, NFC network, and/or RF network with communication links between the player devices 102a-n, the game server 110, and/or the database 140. In some embodiments, the network 104 may comprise direct communications links between any or all of the components 102a-n, 110, 140 of the system 100. The game server 110 may, for example, be directly interfaced or connected to the database 140 via one or more wires, cables, wireless links, and/or other network components, such network components (e.g., communication links) comprising portions of the network 104. In some embodiments, the network 104 may comprise one or many other links or network components other than those depicted in FIG. 1. A second player device 102b may, for example, be connected to the game server 110 via various cell towers, routers, repeaters, ports, switches, and/or other network components that comprise the Internet and/or a cellular telephone (and/or Public Switched Telephone Network (PSTN)) network, and which comprise portions of the network 104.

While the network 104 is depicted in FIG. 1 as a single object, the network 104 may comprise any number, type, and/or configuration of networks that is or becomes known or practicable. According to some embodiments, the network 104 may comprise a conglomeration of different sub-networks and/or network components interconnected, directly or indirectly, by the components 102a-n, 110, 140 of the system 100. The network 104 may comprise one or more cellular telephone networks with communication links between the player devices 102a-n and the game server 110, for example, and/or may comprise the Internet, with communication links between the player devices 102a-n and the database 140, for example.

According to some embodiments, the game server 110 may comprise a device (and/or system) owned and/or operated by or on behalf of or for the benefit of a gaming entity (not explicitly shown). The gaming entity may utilize player and/or game information or instructions (e.g., stored by the database 140), in some embodiments, to host, manage, analyze, design, define, price, conduct, and/or otherwise provide (or cause to be provided) one or more games such as online multiplayer games. In some embodiments, the gaming entity (and/or a third-party; not explicitly shown) may provide an interface (not shown in FIG. 1) to and/or via the player devices 102a-n. The interface may be configured, according to some embodiments, to allow and/or facilitate electronic game play by one or more players. In some embodiments, the system 100 (and/or interface provided by the game server 110) may present game data (e.g., from the database 140) in such a manner that allows players to participate in one or more online games (singularly, in/with groups, and/or otherwise). According to some embodiments, the game server 110 may cause and/or facilitate player allocation and/or reallocation, each as described herein.

In some embodiments, the database 140 may comprise any type, configuration, and/or quantity of data storage devices that are or become known or practicable. The database 140 may, for example, comprise an array of optical and/or solid-state hard drives configured to store player and/or game data, and/or various operating instructions, drivers, etc. While the database 140 is depicted as a stand-alone component of the system 100 in FIG. 1, the database 140 may comprise multiple components. In some embodiments, a multi-component database 140 may be distributed across various devices and/or may comprise remotely dispersed components. Any or all of the player devices 102a-n may comprise the database 140 or a portion thereof, for example, and/or the game server 110 may comprise the database 140 or a portion thereof.

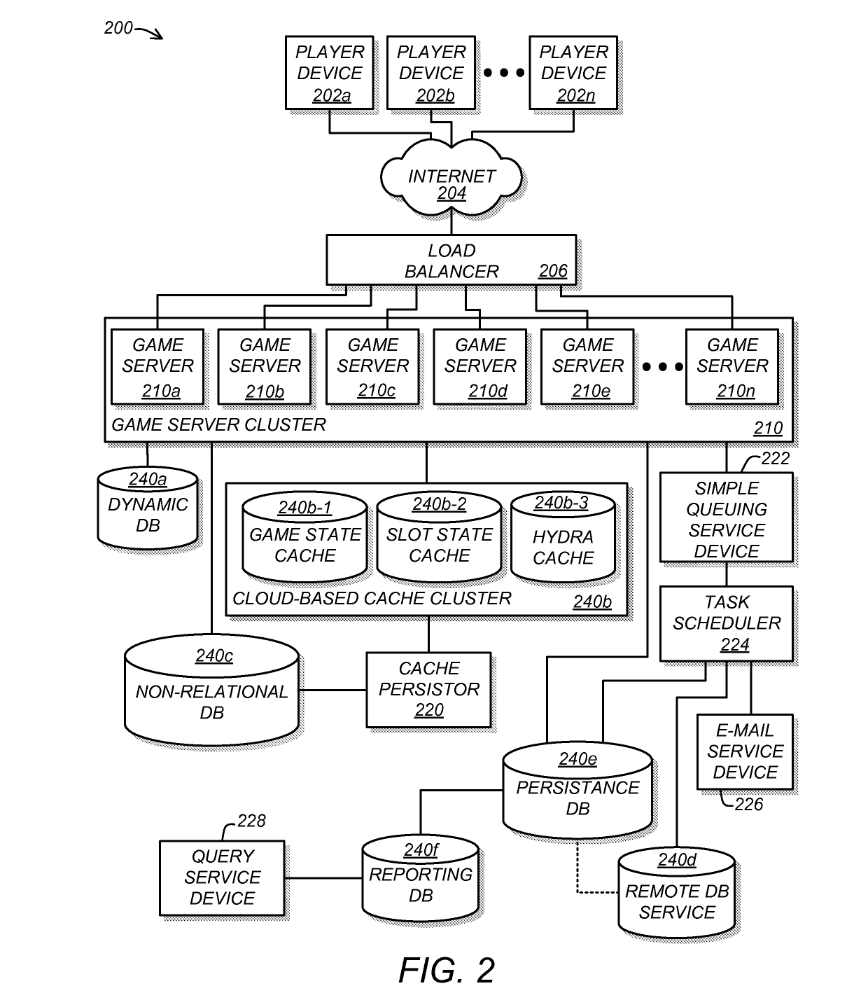

Referring now to FIG. 2, a block diagram of a system 200 according to some embodiments is shown. In some embodiments, the system 200 may comprise a gaming platform such as a platform via which social, multiplayer, and/or online games may be played. In some embodiments, the system 200 may comprise a plurality of player devices 202a-n, the Internet 204, a load balancer 206, and/or a game server cluster 210. The game server cluster 210 may, in some embodiments, comprise a plurality of game servers 210a-n. In some embodiments, the system 200 may comprise a cache persistor 220, a Simple Queuing Service (SQS) device 222, a task scheduler 224, an e-mail service device 226, and/or a query service device 228. As depicted in FIG. 2, any or all of the various components 202a-n, 204, 206, 210a-n, 220, 222, 224, 226, 228 may be in communication with and/or coupled to one or more databases 240a-f. The system 200 may comprise, for example, a dynamic DataBase (DB) 240a, a cloud-based cache cluster 240b (e.g., comprising a game state cache 240b-1, a slot state cache 240b-2, and/or a “hydra” cache 240b-3), a non-relational DB 240c, a remote DB service 240d, a persistence DB 240e, and/or a reporting DB 240f.

According to some embodiments, any or all of the components 202a-n, 204, 206, 210a-n, 220, 222, 224, 226, 228, 240a-f of the system 200 may be similar in configuration and/or functionality to any similarly named and/or numbered components described herein. Fewer or more components 202a-n, 204, 206, 210a-n, 220, 222, 224, 226, 228, 240a-f (and/or portions thereof) and/or various configurations of the components 202a-n, 204, 206, 210a-n, 220, 222, 224, 226, 228, 240a-f may be included in the system 200 without deviating from the scope of embodiments described herein. While multiple instances of some components 202a-n, 210a-n, 240a-f are depicted and while single instances of other components 204, 206, 220, 222, 224, 226, 228 are depicted, for example, any component 202a-n, 204, 206, 210a-n, 220, 222, 224, 226, 228, 240a-f depicted in the system 200 may comprise a single device, a combination of devices and/or components 202a-n, 204, 206, 210a-n, 220, 222, 224, 226, 228, 240a-f, and/or a plurality of devices, as is or becomes desirable and/or practicable. Similarly, in some embodiments, one or more of the various components 202a-n, 204, 206, 210a-n, 220, 222, 224, 226, 228, 240a-f may not be needed and/or desired in the system 200.

According to some embodiments, the player devices 202a-n may be utilized to access (e.g., via the Internet 204 and/or one or more other networks not explicitly shown) content provided by the game server cluster 210. The game server cluster 210 may, for example, provide, manage, host, and/or conduct various online and/or otherwise electronic games such as online bingo, slots, poker, and/or other games of chance, skill, and/or combinations thereof. In some embodiments, the various game servers 210a-n (virtual and/or physical) of the game server cluster 210 may be configured to provide, manage, host, and/or conduct individual instances and/or sessions of available game types. A first game server 210a, for example, may host a first particular session of an online bingo game (or tournament), a second game server 210c may host a second particular session of an online bingo game (or tournament), a third game server 210c may facilitate an online poker tournament (e.g., and a corresponding plurality of game sessions that comprise the tournament), and/or a fourth game server 210d may provide an online slots game (e.g., by hosting one or more slot game sessions).

In some embodiments, the player devices 202a-n may comprise various components (hardware, firmware, and/or software; not explicitly shown) that facilitate game play and/or interaction with the game server cluster 210. The player device 202a-n may, for example, comprise a gaming client such as a software application programmed in Adobe® Flash® and/or HTML 5 that is configured to send requests to, and receive responses from, one or more of the game servers 210a-n of the game server cluster 210. In some embodiments, such an application operating on and/or via the player devices 202a-n may be configured in Model-View-Controller (MVC) architecture with a communication manager layer responsible for managing the requests to/responses from the game server cluster 210. In some embodiments, one or more of the game servers 210a-n may also or alternatively be configured in a MVC architecture with a communication manager and/or communications management layer (not explicitly shown in FIG. 2). In some embodiments, communications between the player devices 202a-n and the game server cluster 210 may be conducted in accordance with the HyperText Transfer Protocol (HTTP) version 1.1 (HTTP/1.1) as published by the Internet Engineering Taskforce (IET) and the World Wide Web Consortium (W3C) in RFC 2616 (June 1999).

According to some embodiments, communications between the player devices 202a-n and the game server cluster 210 may be managed and/or facilitated by the load balancer 206. The load balancer 206 may, for example, route communications from player devices 202a-n to one or more of the specific game servers 210a-n depending upon various attributes and/or variables such as bandwidth availability (e.g., traffic management/volumetric load balancing), server load (e.g., processing load balancing), server functionality (e.g., contextual awareness/availability), and/or player-server history (e.g., session awareness/“stickiness”). In some embodiments, the load balancer 206 may comprise one or more devices and/or services provided by a third-party (not separately shown in FIG. 2). The load balancer 206 may, for example, comprise an Elastic Load Balancer (ELB) service provided by Amazon® Web Services, LLC of Seattle, Wash. According to some embodiments, such as in the case that the load balancer 206 comprises the ELB or a similar service, the load balancer 206 may manage, set, determine, define, and/or otherwise influence the number of game servers 210a-n within the game server cluster 210. In the case that traffic and/or requests from the player devices 202a-n only require the first and second game servers 210a-b, for example, all other game servers 210c-n may be taken off-line, may not be initiated and/or called, and/or may otherwise not be required and/or utilized in the system 200. As demand increases (and/or if performance, security, and/or other issues cause one or more of the first and second game servers 210a-b to experience detrimental issues), the load balancer 206 may call and/or bring online one or more of the other game servers 210c-n depicted in FIG. 2. In the case that each game server 210a-n comprises an instance of an Amazon® Elastic Compute Cloud (EC2) service, the load balancer 206 may add or remove instances as is or becomes practicable and/or desirable.

In some embodiments, the load balancer 206 and/or the Internet 204 may comprise one or more proxy servers and/or devices (not shown in FIG. 2) via which communications between the player devices 202a-n and the game server cluster 210 are conducted and/or routed. Such proxy servers and/or devices may comprise one or more regional game hosting centers, for example, which may be geographically dispersed and addressable by player devices 202a-n in a given geographic proximity. In some embodiments, the proxy servers and/or devices may be located in one or more geographic areas and/or jurisdictions while the game server cluster 210 (and/or certain game servers 210a-n and/or groups of game servers 210a-n thereof) is located in a separate and/or remote geographic area and/or jurisdiction.

According to some embodiments, for specific game types such as bingo, the game server cluster 210 may provide game results (such as a full set of drawn bingo numbers and/or bonus metrics) to a controller device (not separately shown in FIG. 2) that times the release of game result information to the player devices 202a-n such as by utilizing a broadcaster device (also not separately shown in FIG. 2) that transmits the time-released game results to the player devices 202a-n (e.g., in accordance with the Transmission Control Protocol (TCP) and Internet Protocol (IP) suite of communications protocols (TCP/IP), version 4, as defined by “Transmission Control Protocol” RFC 793 and/or “Internet Protocol” RFC 791, Defense Advance Research Projects Agency (DARPA), published by the Information Sciences Institute, University of Southern California, J. Postel, ed. (September 1981)).

In some embodiments, the game server cluster 210 (and/or one or more of the game servers 210a-n thereof) may be in communication with the dynamic DB 240a. According to some embodiments, the dynamic DB 240a may comprise a dynamically-scalable database service such as the DyanmoDB™ service provided by Amazon® Web Services, LLC. The dynamic DB 240a may, for example, store information specific to one or more certain game types (e.g., slots) provided by the game server cluster 210 such as to allow, permit, and/or facilitate reporting and/or analysis of such information.

According to some embodiments, the game server cluster 210 (and/or one or more of the game servers 210a-n thereof) may be in communication with the cloud-based cache cluster 240b. Game state information from the game server cluster 210 may be stored in the game state cache 240b-1, for example, slot state (e.g., slot-game specific state) data may be stored in the slot state cache 240b-2, and/or other game and/or player information (e.g., progressive data, referral data, player rankings, audit data) may be stored in the hydra cache 240b-3. In some embodiments, the cache persistor 220 may move and/or copy data stored in the cloud-based cache cluster 240b to the non-relational DB 240c. The non-relational DB 240c may, for example, comprise a SimpleDB™ service provided by Amazon® Wed Services, LLC. According to some embodiments, the game server cluster 210 may generally access the cloud-based cache cluster 240b as-needed to store and/or retrieve game-related information. The data stored in the cloud-based cache cluster 240b may generally comprise a subset of the newest or freshest data, while the cache persistor 220 may archive and/or store or move such data to the non-relational DB 240c as it ages and/or becomes less relevant (e.g., once a player logs-off, once a game session and/or tournament ends). The game server cluster 210 may, in accordance with some embodiments, have access to the non-relational DB 240c as-needed and/or desired. The game servers 210a-n may, for example, be initialized with data from the non-relational DB 240c and/or may store and/or retrieve low frequency and/or low priority data via the non-relational DB 240c.

In some embodiments, the SQS device 222 may queue and/or otherwise manage requests, messages, events, and/or other tasks or calls to and/or from the server cluster 210. The SQS device 222 may, for example, prioritize and/or route requests between the game server cluster 210 and the task scheduler 224. In some embodiments, the SQS device 222 may provide mini-game and/or tournament information to the server cluster 210. According to some embodiments, the task scheduler 224 may initiate communications with the SQS device 222, the e-mail service provider 226 (e.g., providing e-mail lists), the remote DB service 240d (e.g., providing inserts and/or updates), and/or the persistence DB 240e (e.g., providing and/or updating game, player, and/or other reporting data), e.g., in accordance with one or more schedules.

According to some embodiments, the persistence DB 240e may comprise a data store of live environment game and/or player data. The game server cluster 210 and/or the task scheduler 224 or SQS device 222 may, for example, store game and/or player data to the persistence DB 240e and/or may pull and/or retrieve data from the persistence DB 240e, as-needed and/or desired. The server cluster 210 may, according to some embodiments, provide and/or retrieve spin and/or other game event info and/or configuration information via the persistence DB 240e.

In some embodiments, the reporting DB 240f may be created and/or populated based on the persistence DB 240e. On a scheduled and/or other basis, for example, a data transformation and/or mapping program may be utilized to pull data from the live environment (e.g., the persistence DB 240e) into the reporting DB 240f. The query service 228 may then be utilized, for example, to query the reporting DB 240f, without taxing the live environment and/or production system directly accessible by the game server cluster 210.

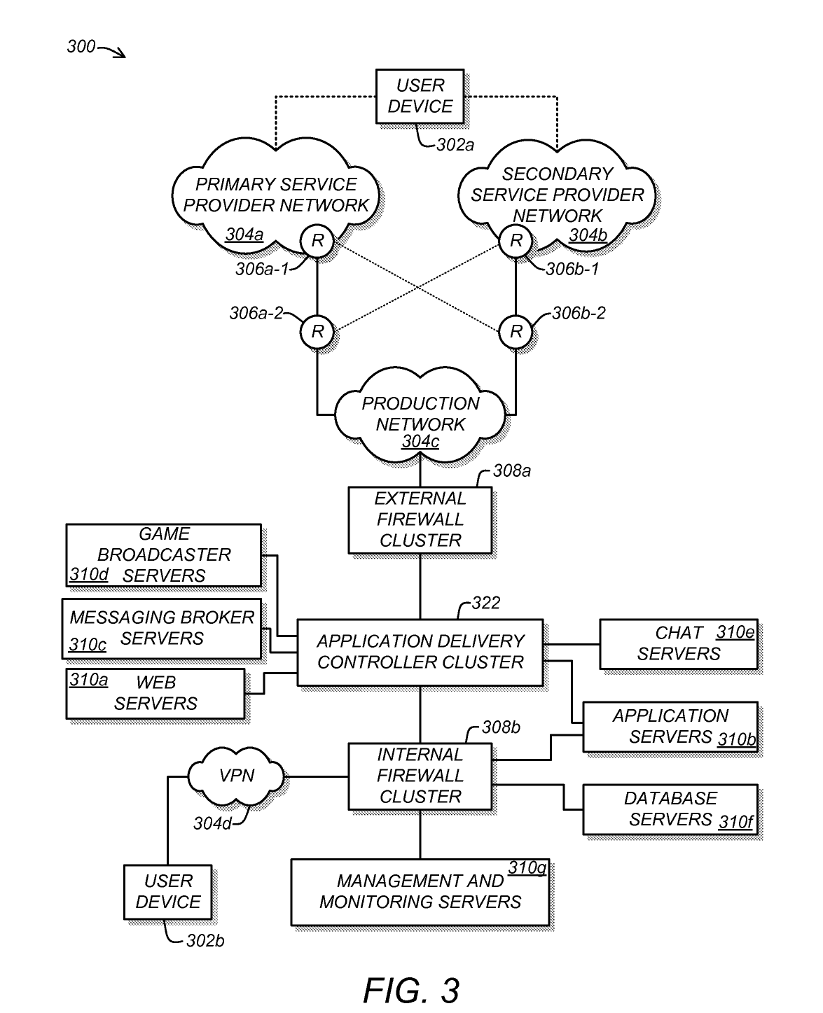

Turning now to FIG. 3, a block diagram of a system 300 according to some embodiments is shown. In some embodiments, the system 300 may comprise and/or define a “front-end” architecture of a gaming platform such as a platform via which social, multiplayer, and/or online games may be played. In some embodiments, the system 300 may comprise a plurality of user devices 302a-b, a plurality of networks 304a-b (e.g., a primary service provider network 304a, a secondary service provider network 304b, a production network 304c, and/or a VPN 304d), a plurality of routers 306a-b, a plurality of firewall devices 308a-b, a plurality of game servers 310a-g (e.g., web servers 310a, application servers 310b, messaging broker servers 310c, game broadcaster servers 310d, chat servers 310e, database servers 310f, and/or management and monitoring servers 310g), and/or an application delivery controller cluster 322.

According to some embodiments, any or all of the components 302a-b, 304a-b, 306a-b, 308a-b, 310a-g, 322 of the system 300 may be similar in configuration and/or functionality to any similarly named and/or numbered components described herein. Fewer or more components 302a-b, 304a-b, 306a-b, 308a-b, 310a-g, 322 (and/or portions thereof) and/or various configurations of the components 302a-b, 304a-b, 306a-b, 308a-b, 310a-g, 322 may be included in the system 300 without deviating from the scope of embodiments described herein. While multiple instances of some components 302a-b, 304a-b, 306a-b, 308a-b, 310a-g are depicted and while single instances of other components 322 are depicted, for example, any component 302a-b, 304a-b, 306a-b, 308a-b, 310a-g, 322 depicted in the system 300 may comprise a single device, a combination of devices and/or components 302a-b, 304a-b, 306a-b, 308a-b, 310a-g, 322, and/or a plurality of devices, as is or becomes desirable and/or practicable. Similarly, in some embodiments, one or more of the various components 302a-b, 304a-b, 306a-b, 308a-b, 310a-g, 322 may not be needed and/or desired in the system 300.

In some embodiments, a first user device 304a may comprise an electronic device owned and/or operated by a player of an online game (not explicitly shown) and/or by an entity that otherwise accesses online game content and/or services externally (e.g., requiring external login and/or access credentials and/or procedures). The first user device 304a may, for example, be utilized to access content provided by and/or via the application delivery controller cluster 322. In some embodiments, the first user device 304a may interface with and/or connect to the production network 304c via the primary service provider network 304a and/or the secondary service provider network 304b. The primary service provider network 304a and the secondary service provider network 304b may, for example, load balance and/or provide redundant coverage for outage recovery by utilization of a first primary service provider network router 306a-1, a second primary service provider network router 306a-2, a first secondary service provider network router 306b-1, and/or a second secondary service provider network router 306b-2.

According to some embodiments, the application delivery controller cluster 322 may be insulated and/or protected from the production network 304c by an external firewall cluster 308a. The first user device 304a may, for example, be required to provide credentials to and/or otherwise access the application delivery controller cluster 322 via the external firewall cluster 308a.

In some embodiments, the application delivery controller cluster 322 may receive via and/or from the external firewall cluster 308a and/or the production network 304c, one or more requests, calls, transmissions, and//or commands from the first user device 304a. The first user device 304a may, for example, submit a call for an online gaming interface to the application delivery controller cluster 322. In some embodiments, the application delivery controller cluster 322 may comprise one or more hardware, software, and/or firmware devices and/or modules configured (e.g., specially-programmed) to route events and/or responses between the first user device 304a and one or more of the servers 310a-g. In the case that the first user device 304a is utilized to access an online gaming interface for example, one or more of the web servers 310a (e.g., that may provide graphical and/or rendering elements for an interface and/or other web services) and/or the application servers 310b (e.g., that may provide rule and/or logic-based programming routines, elements, and/or functions—e.g., game play engines) may be called and/or managed by the application delivery controller cluster 322.

In some embodiments, the messaging broker servers 310c may receive and/or retrieve messages from the first user device 304a (and/or from one or more of the other servers 310a-b, 310d-g) and perform one or more inter-application processes in relation thereto. The messaging broker servers 310c may, for example, route, transform, consolidate, aggregate, store, augment, and/or otherwise process one or more requests in connection with provision of online gaming services to the first user device 304a (e.g., facilitating a decoupling of services provided by various applications on and/or from the various servers 310a-b, 310d-g). According to some embodiments, the game broadcaster servers 310d may provide scheduled releases of information descriptive of an online game. The game broadcaster servers 310d may, for example, provide a broadcast feed of bingo numbers, slot and/or other random (and/or pseudo-random) number results that may be accessed by (and/or transmitted to) the first user device 304a (e.g., in connection with the play of an online bingo, slots, and/or other game for which broadcast information may be utilized). In some embodiments, the chat servers 310e may provide, manage, and/or facilitate communications between the first user device 304a (and/or first user thereof) and one or more other player/user devices (such as a second user device 302b and/or other player/user devices not shown in FIG. 3).

According to some embodiments, the second user device 304b may generally comprise an electronic device owned and/or operated by a user (not shown) closely affiliated with an entity that operates the system 300 (such entity also not shown). An employee (e.g., programmer and/or Customer Service Representative (CSR)), contractor, and/or other agent of an online gaming company may, for example, utilize the second user device 304b to interface with the privately-accessible VPN 304d. The VPN 304d may, for example, provide direct access to the application servers 310b, the database servers 310f, the management and monitoring servers 310g, and/or the application delivery controller cluster 322. In some embodiments (as depicted in FIG. 3), such access may be gated through and/or insulated or protected by an internal firewall cluster 308b. The second user device 304b may, for example, be required to provide credentials to and/or otherwise access the application delivery controller cluster 322 and/or servers 310a-g via the internal firewall cluster 308b.

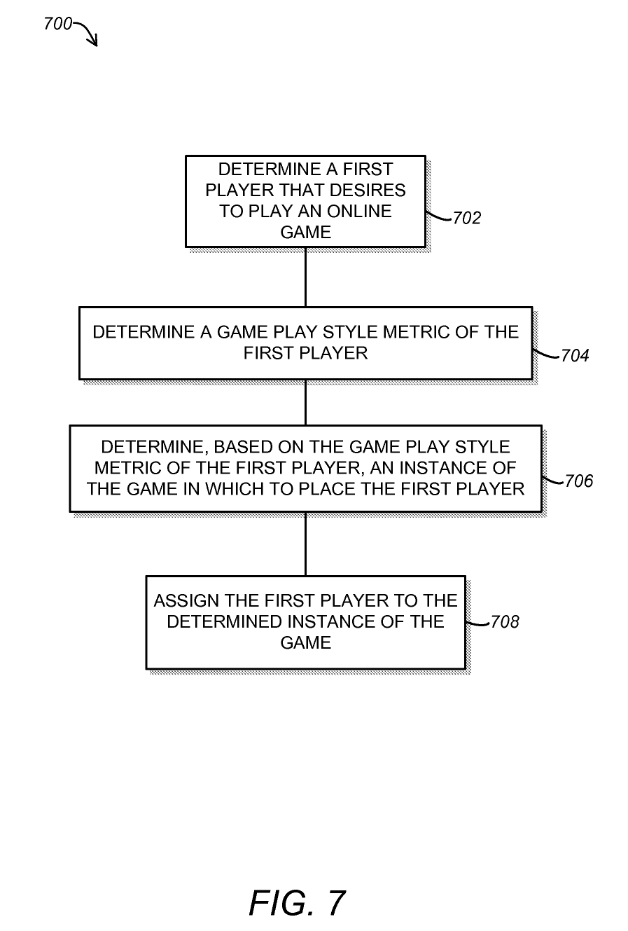

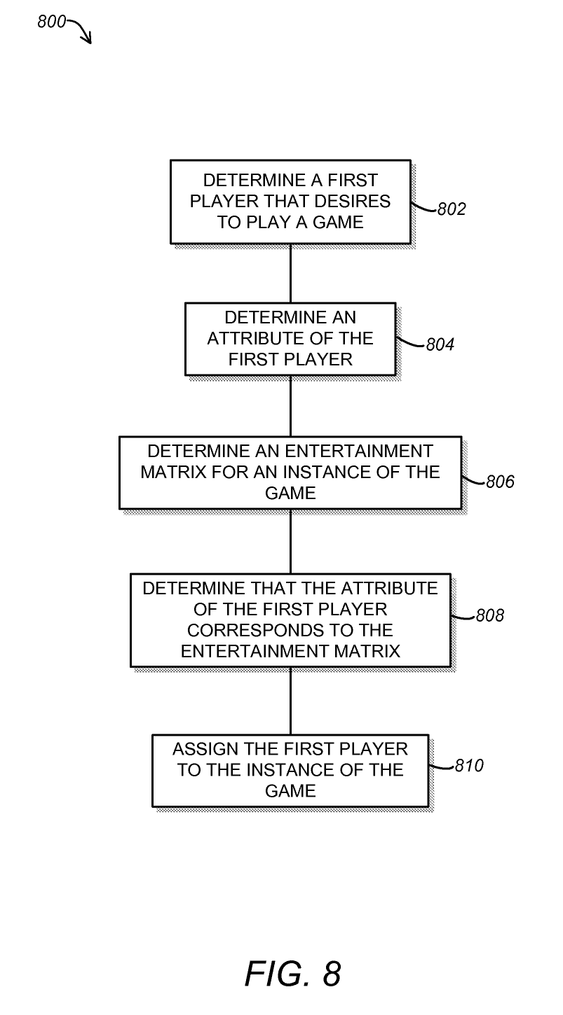

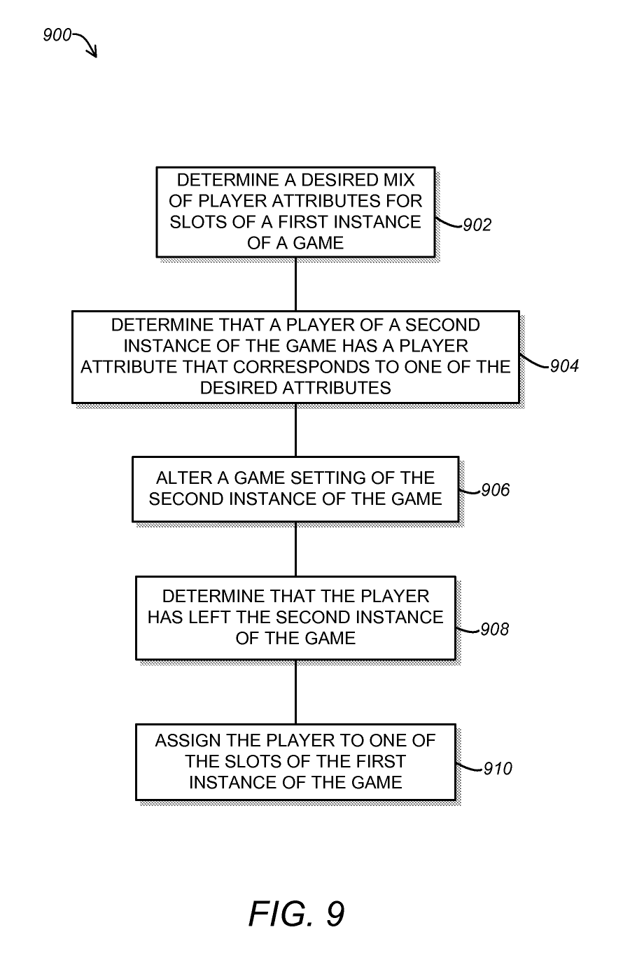

In some embodiments, the database servers 310f may provide access to one or more databases and/or data stores (e.g., not shown in FIG. 3; for data storage and/or retrieval). In some embodiments, the management and monitoring servers 310g may provide services such as monitoring, reporting, troubleshooting, analysis, configuring, etc. to the second user device 304b. The second user device 304b may, for example, access the management and monitoring servers 310g and/or the database servers 310f to run reports descriptive of online gaming operations, game play, and/or game referral setup, management, and/or analysis. According to some embodiments, either or both of the user devices 304a-b in conjunction with one or more of the servers 310a-g and/or the application delivery controller cluster 322 may conduct (in whole or in part), facilitate, and/or otherwise be associated with execution of one or more stored procedures, applications, processes, and/or methods (e.g., the methods 700, 800, 900 of FIG. 7, FIG. 8 and/or FIG. 9 herein, and/or one or more portions and/or combinations thereof).

Utilization of the term “server” with respect to the servers 310a-g of the system 300 of FIG. 3 is meant solely to ease description of the configuration and/or functionality of the servers 310a-g. The term “server” is not intended to be limiting with respect to any particular hardware, software, firmware, and/or quantities thereof utilized to implement any or all of the servers 310a-g of the system 300. Similarly, while multiple types and/or instances of the severs 310a-g are depicted in FIG. 3, any or all of the servers 310a-g may be implemented in, on, and/or by one or multiple computer server and/or other electronic devices.

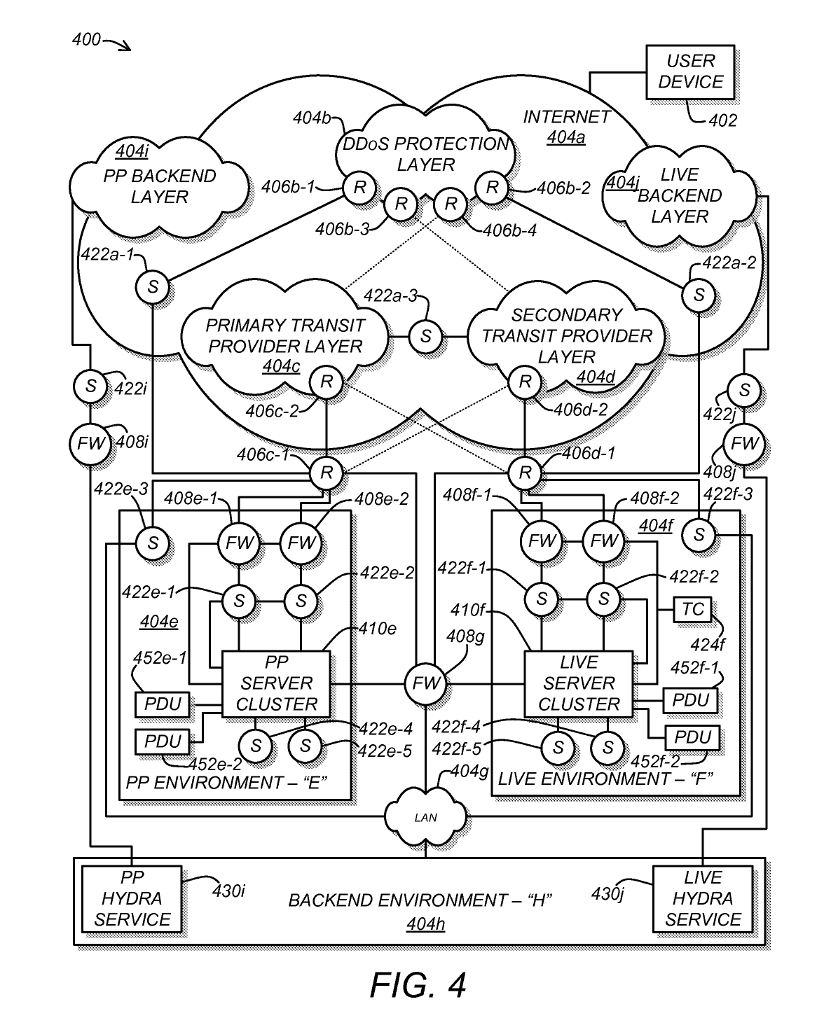

Referring now to FIG. 4, a block diagram of a system 400 according to some embodiments is shown. In some embodiments, the system 400 may comprise and/or define a “front-end” architecture of a gaming platform such as a platform via which social, multiplayer, and/or online games may be played. The system 400 may be similar in configuration and/or functionality, for example, to the system 300 of FIG. 3 and/or one or more portions thereof. In some embodiments, the system 400 may comprise a user device 402, a plurality of networks (and/or environments and/or layers) 404a-j (e.g., the Internet 404a, a Distributed Denial-of-Service (DDoS) protection layer 404b, a primary transit provider layer 404c, a secondary transit provider layer 404d, a Pre-Production (PP) environment 404e, a live environment 404f, a LAN 404g, a backend environment 404h, a PP backend layer 404i, and/or a live backend layer 404j), a plurality of routers 406b-d, a plurality of firewall devices 408e-g, 408i-j, a plurality of servers 410e-f (e.g., a PP server cluster 410e and/or a live server cluster 410f), a plurality of switching devices 422a, 422e-f, 422i-j, a Terminal Concentrator (TC) 424f, a plurality of “hydra” services 430i-j (e.g., a PP hydra service 430i and/or a live hydra service 430j), and/or a plurality of Power Distribution Unit (PDU) devices 452e-f.

According to some embodiments, any or all of the components 402, 404a-j, 406b-d, 408e-g, 408i-j, 410e-f, 422a, 422e-f, 422i-j, 424f, 430i-j, 452e-f of the system 400 may be similar in configuration and/or functionality to any similarly named and/or numbered components described herein. Fewer or more components 402, 404a-j, 406b-d, 408e-g, 408i-j, 410e-f, 422a, 422e-f, 422i-j, 424f, 430i-j, 452e-f (and/or portions thereof) and/or various configurations of the components 402, 404a-j, 406b-d, 408e-g, 408i-j, 410e-f, 422a, 422e-f, 422i-j, 424f, 430i-j, 452e-f may be included in the system 400 without deviating from the scope of embodiments described herein. While multiple instances of some components 404a-j, 406b-d, 408e-g, 408i-j, 410e-f, 422a, 422e-f, 422i-j, 430i-j, 452e-f are depicted and while single instances of other components 402, 424f are depicted, for example, any component 402, 404a-j, 406b-d, 408e-g, 408i-j, 410e-f, 422a, 422e-f, 422i-j, 424f, 430i-j, 452e-f depicted in the system 400 may comprise a single device, a combination of devices and/or components 402, 404a-j, 406b-d, 408e-g, 408i-j, 410e-f, 422a, 422e-f, 422i-j, 424f, 430i-j, 452e-f, and/or a plurality of devices, as is or becomes desirable and/or practicable. Similarly, in some embodiments, one or more of the various components 402, 404a-j, 406b-d, 408e-g, 408i-j, 410e-f, 422a, 422e-f, 422i-j, 424f, 430i-j, 452e-f may not be needed and/or desired in the system 400.

In some embodiments, the user device 402 may be utilized to access one or more of the PP environment 404e, the live environment 404f, and/or the backend environment 404h via the Internet 404a. In some embodiments, the user device 402 may be utilized to access the backend environment 404h and/or the PP hydra service 430i via the PP backend layer 404i. A PP backend switch device 422i and/or a PP backend firewall device 408i may, for example, gate and/or control access to the backend environment 404h and/or the PP hydra service 430i, via the PP backend layer 404i. In some embodiments, the user device 402 may be utilized to access the backend environment 404h and/or the live hydra service 430j via the live backend layer 404j. A live backend switch device 422j and/or a live backend firewall device 408j may, for example, gate and/or control access to the backend environment 404h and/or the live hydra service 430j, via the live backend layer 404j.

According to some embodiments, any communications (e.g., requests, calls, and/or messages) from the user device 402 may be passed through the DDoS protection layer 404b. The DDoS protection layer 404b may, for example, monitor and/or facilitate protection against various forms of cyber attacks including, but not limited to, DDoS attacks. In some embodiments, the DDoS protection layer 404b may comprise and/or be in communication with a plurality of DDoS router devices 406b-1, 406b-2, 406b-3, 406b-4 that may be utilized to route and/or direct incoming communications (e.g., from the user device 402) to appropriate portions of the system 400.

In some embodiments, the DDoS protection layer 404b and/or a first DDoS router device 406b-1 may route communications from the user device 402 through and/or via a first switch device 422a-1 and/or to, through, and/or via a first primary transit provider router device 406c-1. In some embodiments, the first switch device 422a-1 may comprise a device utilized for security switching such as may implement communications in accordance with the Generic Routing Encapsulation (GRE) communications tunneling protocol described in RFC 2784 “Generic Routing Encapsulation (GRE)” published by the Network Working Group (NWG) in March, 2000. The first primary transit provider router device 406c-1 may, for example, provide access to the PP environment 404e and/or the PP server cluster 410e thereof, such as via one or more PP firewall devices 408e-1, 408e-2 and/or one or more PP switch devices 422e-1, 422e-2. According to some embodiments, the PP switch devices 422e-1, 422e-2 may comprise content switching devices that process and route data (e.g., in the data link layer) based on data content. In some embodiments, the first primary transit provider router device 406c-1 may direct communications to, through, and/or via a PP LAN switch device 422e-3 that provides and/or facilitates access to the LAN 404g. The LAN 404g may, for example, provide private access to and/or between the PP environment 404e, the live environment 404f, and/or the backend environment 404h. In some embodiments, the first primary transit provider router device 406c-1 and/or the PP LAN switch device 422e-3 may direct communications to, through, and/or via a LAN firewall device 408g that provides direct access to either or both of the PP server cluster 410e and the live server cluster 410f.

According to some embodiments, the DDoS protection layer 404b and/or a second DDoS router device 406b-2 may route communications from the user device 402 through and/or via a second switch device 422a-2 and/or to, through, and/or via a first secondary transit provider router device 406d-1. In some embodiments, the second switch device 422a-2 may comprise a device utilized for security switching such as may implement communications in accordance with the GRE communications tunneling protocol described in RFC 2784 “Generic Routing Encapsulation (GRE)” published by the Network Working Group (NWG) in March, 2000. The first secondary transit provider router device 406d-1 may, for example, provide access to the live environment 404f and/or the live server cluster 410f thereof, such as via one or more live firewall devices 408f-1, 408f-2 and/or one or more live switch devices 422f-1, 422f-2. According to some embodiments, the live switch devices 422f-1, 422f-2 may comprise content switching devices that process and route data (e.g., in the data link layer) based on data content. In some embodiments, the first secondary transit provider router device 406d-1 may direct communications to, through, and/or via a live LAN switch device 422f-3 that provides and/or facilitates access to the LAN 404g. In some embodiments, the first secondary transit provider router device 406d-1 and/or the live LAN switch device 422f-3 may direct communications to, through, and/or via the LAN firewall device 408g that provides direct access to either or both of the PP server cluster 410e and the live server cluster 410f.

In some embodiments, the DDoS protection layer 404b and/or one or more of a third DDoS router device 406b-3 and/or a fourth DDoS router device 406b-4 may route communications from the user device 402 through and/or via one or more of the primary transit provider layer 404c and/or the secondary transit provider layer 404d. In some embodiments, a transit provider switch device 422a-3 may direct, swap, route, and/or manage communications between the primary transit provider layer 404c and the secondary transit provider layer 404d. According to some embodiments, the transit provider switch device 422a-3 may comprise a switching device that operates in accordance with an Exterior Border Gateway Protocol (EBGP)—e.g., the transit provider switch device 422a-3 may comprise one or more edge or border routers. In some embodiments, the first primary transit provider router device 406c-1, the first secondary transit provider router device 406d-1, a second primary transit provider router device 406c-2, and/or a second secondary transit provider router device 406d-2 may be utilized to route and/or direct communications between (i) the primary transit provider layer 404c and/or the secondary transit provider layer 404d and (ii) the PP environment 404e and/or the live environment 404f.

According to some embodiments, the PP server cluster 410e and/or the PP environment 404e may comprise various hardware, software, and/or firmware that permits a user (e.g., of the user device 402) to program, edit, manage, and/or otherwise interface with PP game elements and/or interfaces (e.g., for development and/or testing purposes). In some embodiments, the PDU devices 452e-1, 452e-2 may generally provide power distribution, supply, management, backup, and/or conditioning services (e.g., to the PP server cluster 410e) as is or becomes desired. According to some embodiments, additional switch devices 422e-4, 422e-5 may be utilized to distribute, balance, manage and/or control communications to, from, and/or within the PP server cluster 410e.

In some embodiments, the live server cluster 410f and/or the live environment 404f may comprise various hardware, software, and/or firmware that permits a user (e.g., of the user device 402) to program, edit, manage, and/or otherwise interface with live game elements and/or interfaces (e.g., for troubleshooting, corrective, and/or live environment management purposes). In some embodiments, the PDU devices 452f-1, 452f-2 may generally provide power distribution, supply, management, backup, and/or conditioning services (e.g., to the live server cluster 410f) as is or becomes desired. According to some embodiments, additional switch devices 422f-4, 422f-5 may be utilized to distribute, balance, manage and/or control communications to, from, and/or within the live server cluster 410f. In some embodiments, the TC device 424f may be utilized to manage communications from a variety of data sources such as by providing communication capability between various communications channels (not separately depicted in FIG. 4).

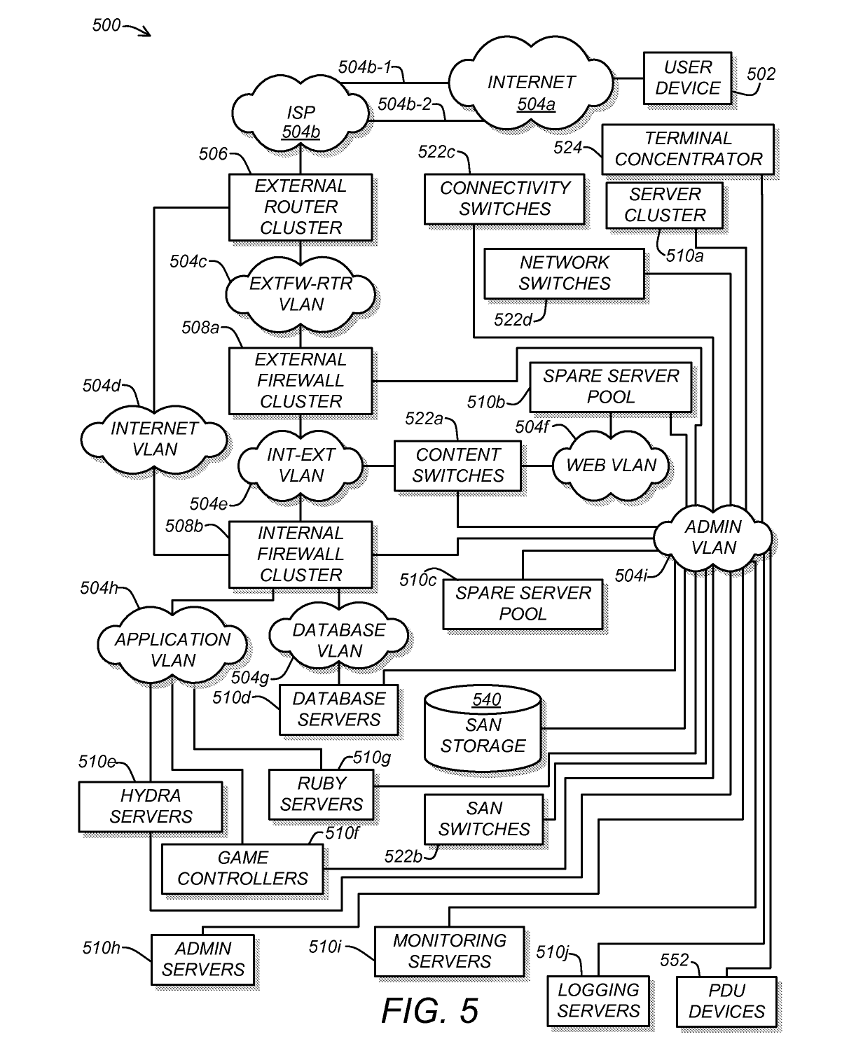

Turning to FIG. 5, a block diagram of a system 500 according to some embodiments is shown. In some embodiments, the system 500 may comprise and/or define a “back-end” architecture of a gaming platform such as a platform via which social, multiplayer, and/or online games may be played. The system 500 may be utilized in conjunction with the systems 300, 400 if FIG. 3 and/or FIG. 4 herein, for example, and/or may be similar in configuration and/or functionality to the backend environment 404h of the system 400 of FIG. 4. In some embodiments, the system 500 may comprise a user device 502, a plurality of networks (and/or environments and/or layers) 504a-i (e.g., the Internet 504a, an ISP 504b, an External Firewall-Router (EXTFW-RTR) Virtual LAN (VLAN) 504c, an Internet VLAN 504d, an Internal-External (INT-EXT) VLAN 504e, a web VLAN 504f, a database VLAN 504g, an application VLAN 504h, and/or an administrator VLAN 504i), an external router cluster 506, a plurality of firewall clusters 508a-b (e.g., an external firewall cluster 508a and/or an internal firewall cluster 508b), a plurality of servers 510a-j (e.g., a server cluster 510a, a first spare server pool 510b, a second spare server pool 510c, database servers 510d, “hydra” servers 510e, game controllers 510f, ruby servers 510g, admin servers 510h, monitoring servers 510i, and/or logging servers 510j), a plurality of switches 522a-d (e.g., content switches 522a, Storage Area Network (SAN) switches 522b, connectivity switches 522c, and/or network switches 522d), a TC device 524, a SAN storage device 540, and/or one or more PDU devices 552.

According to some embodiments, any or all of the components 502, 504a-l, 506, 508a-b, 510a-j, 522a-d, 524, 540, 552 of the system 500 may be similar in configuration and/or functionality to any similarly named and/or numbered components described herein. Fewer or more components 502, 504a-l, 506, 508a-b, 510a-j, 522a-d, 524, 540, 552 (and/or portions thereof) and/or various configurations of the components 502, 504a-l, 506, 508a-b, 510a-j, 522a-d, 524, 540, 552 may be included in the system 500 without deviating from the scope of embodiments described herein. While multiple instances of some components 504a-l, 508a-b, 510a-j, 522a-d are depicted and while single instances of other components 502, 506, 524, 540, 552 are depicted, for example, any component 502, 504a-l, 506, 508a-b, 510a-j, 522a-d, 524, 540, 552 depicted in the system 500 may comprise a single device, a combination of devices and/or components 502, 504a-l, 506, 508a-b, 510a-j, 522a-d, 524, 540, 552, and/or a plurality of devices, as is or becomes desirable and/or practicable. Similarly, in some embodiments, one or more of the various components 502, 504a-l, 506, 508a-b, 510a-j, 522a-d, 524, 540, 552 may not be needed and/or desired in the system 500.

In some embodiments, the user device 502 may be utilized to access and/or interface with one or more of the servers 510a-j via the Internet 504a. In some embodiments, the Internet 502a may be linked to the ISP 504b via multiple (e.g., redundant) connectivity paths 504b-1, 504b-2 (e.g., for load balancing, security, and/or failure recovery). According to some embodiments, the ISP 504b may be in communication with (and/or comprise) the external router cluster 506. The external router cluster 506 may route certain requests, calls, and/or transmissions (and/or users—e.g., based on credentials and/or other information) through the EXTFW-RTR VLAN 504c and/or through the external firewall cluster 508a, for example, and/or may route certain requests, calls, and/or transmissions (and/or users—e.g., based on credentials and/or other information) through the Internet VLAN 504d and/or through the internal firewall cluster 508b.

In the case that a user (not shown) of the user device 502 comprises an online game player, consumer, and/or other member of the public, for example, the external router cluster 506 may direct communications through the EXTFW-RTR VLAN 504c and/or through the external firewall cluster 508a. In the case that the user of the user device 502 comprises a programmer, tester, employee, and/or other agent of an entity that operates the system 500, for example, the external router cluster 506 may direct communications through the Internet VLAN 504d and/or through the internal firewall cluster 508b. In some embodiments, access via either or both of the external firewall cluster 508a and/or the internal firewall cluster 508b may permit the user device 502 to communicate via the INT-EXT VLAN 504e. The INT-EXT VLAN 504e may, for example, provide access to the content switches 522a which may, in some embodiments, serve content from any or all of the servers 510a-j to the user device 502, as is or becomes appropriate or desired. In some embodiments, the content switches 522a may communicate with the first spare server pool 510b via the web LAN 504f.

According to some embodiments, private and/or other specialized access to the system 500 via the internal firewall cluster 508b may permit the user device 502 to communicate via one or more of the database VLAN 504g, the application VLAN 504h, and/or the admin VLAN 504i. The database VLAN 504g may be utilized, for example, to access and/or communicate with the database servers 510d. In some embodiments, the application VLAN 504h may be utilized to access and/or communicate with any or all of the hydra servers 510e, the game controllers 510f, and/or the ruby servers 510g.

The admin VLAN 504i may allow, promote, conduct, facilitate, and/or manage a wide variety of communications within the system 500. The admin VLAN 504i may, for example, communicatively connect and/or couple any or all of the firewalls 508a-b, the servers 510a-j, the switches 522a-d, the TC device 524, the SAN storage 540, and/or the PDU devices 552. The user device 502 may be utilized, in conjunction with the admin servers 510h and/or via the admin VLAN 504i for example, to define, edit, adjust, manage, and/or otherwise access settings (and/or data) of the firewalls 508a-b, any or all of the switches 522a-d, the TC device 524, and/or the PDU devices 552. In some embodiments, the user device 502 (and/or the admin servers 510h) may be utilized to manage and/or access content, rules, settings, and/or performance characteristics or preferences for any or all of the servers 510a-j.

In some embodiments, the server cluster 510a may comprise one or more servers and/or other electronic controller devices (e.g., blade servers) configured to provide online gaming data (e.g., interfaces and/or results) to the user device 502. According to some embodiments, the first spare server pool 510b and/or the second spare server pool 510c may comprise one or more server and/or other electronic controller devices configured to supplement and/or replace the server cluster 510a as needed and/or desired (e.g., to manage load and/or error recovery situations). In some embodiments, the database servers 510c may provide and/or manage access to stored data such as data stored in and/or by the SAN storage device 540. In some embodiments, the hydra servers 510e and/or the game controllers 510f may provide online game information such as interfaces, results, graphics, sounds, and/or other media to the user device 502 (e.g., via the application VLAN 504h). In some embodiments, the ruby servers 510g may comprise one or more processing devices configured to provide access to one or more programming languages (e.g., “Ruby”) and/or Application Programming Interface (API) mechanisms via which the servers 510a-j and/or other portions of the system 500 may be configured to operate (e.g., in accordance with specially and/or pre-programmed instructions written in the programming language and/or developed by the API provided by the ruby servers 510g). According to some embodiments, the admin servers 510h, the monitoring servers 510i, and/or the logging servers 510j may be utilized and/or configured to provide administrative, parameter and/or metric monitoring and/or reporting, and/or data logging and/or audit services, respectively.

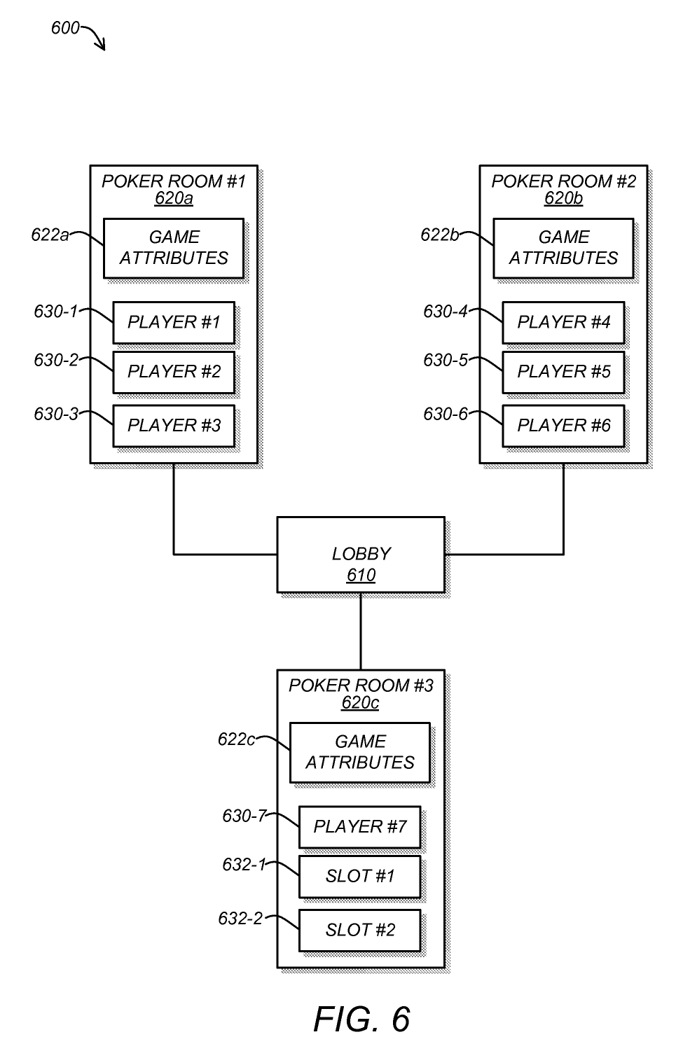

Referring now to FIG. 6, a block diagram of a system 600 according to some embodiments is shown. In some embodiments, the system 600 may comprise a game lobby 610 and/or one or more game instances 620a-c. In some embodiments, each game instance 620a-c may comprise one or more game attributes 622a-c and/or one or more players 630. In some embodiments, the system 600 may be facilitated, implemented, and/or effectuated by one or more of the systems 100, 200, 300, 400, 500 of FIG. 1, FIG. 2, FIG. 3, FIG. 4, and/or FIG. 5, and/or one or more components, portions, and/or combinations thereof.

According to some embodiments, a first game instance 620a (e.g., the “Poker Room #1”) may include a first player 630-1 (“Player #1”), a second player 630-2 (“Player #2”), and/or a third player 630-3 (“Player #3”). In some embodiments, a second game instance 620b (e.g., the “Poker Room #2”) may include a fourth player 630-4- (“Player #4”), a fifth player 630-5 (“Player #5”), and/or a sixth player 630-6 (“Player #6”). According to some embodiments, a third game instance 620c (e.g., the “Poker Room #3”) may include a seventh player 630-7 (“Player #7”) and/or a first player slot 632-1 (“Slot #1”), and/or a second player slot 632-2 (“Slot #2”). According to some embodiments, any one or more of the players 630 may also or alternatively be in the game lobby 610.

In some embodiments, it may be desirable to fill one or more of the player slots 632 of the third game instance 620c with one or more of the players 630 from either of both of the other game instances 620a-b. It may be determined, for example, that the first player 630-1 has a game play style attribute and/or game play style metric that would be compatible with a game play style attribute and/or game play style metric of the seventh player 630-7. In some embodiments, a player game play style attribute and/or game play style metric may specifically exclude attributes and/or metrics indicative of player skill—e.g., number of wins, losses, amount of winnings, etc. Even if the first player 630-1 is much more highly skilled than the seventh player 630-7, for example, it may be determined that combining the two players 630-1, 630-7 in the same game instance (e.g., the third game instance 620c) may be likely to result in an entertaining experience for one or more of the two players 630-1, 630-7.

According to some embodiments, a game play style metric may be determined based on one or more game play characteristics of a player (e.g., non-skill-based characteristics). Game play style metrics (and/or an associated metric thereof) may, for example, be based on (i) a likelihood (frequency, average occurrence, etc.) that a player will put Voluntary Pay in Pot (VPIP) in a poker and/or similar-style game—e.g., how often they voluntarily put money in the pot, (ii) a likelihood (frequency, average occurrence, etc.) of the player initiating a Pre-Flop Raise (PFR), (iii) a likelihood (frequency, average occurrence, etc.) that the player will play a speculative drawing hand—e.g., playing small pairs (e.g., “33”, “66”), or suited connectors (e.g., “5s4s”, “8h7h”), which wouldn't necessarily otherwise show in basic stats for the player, because the player might play hands like “33” and “54s”, but not play hands like “ATo” and “KJo”, for the same total percentage of hands played (e.g., a stylistic difference, and a subtle difference in strategy), (iv) a likelihood (frequency, average occurrence, etc.) that the player will play big pots—e.g., such a player might call a raise with a lousy hand just because four (4) other players are already involved and he wants a chance at a really big score, (v) how a player varies their raises in and/or across game sessions, (vi) a magnitude (total, average, etc.) of raises the player makes or is likely to make, and/or (vii) how talkative the player is (e.g., verbal, text chat, or other electronic communication mechanisms amongst players).

In some embodiments, such non-skill-based metrics based on the player's game play style (e.g., play characteristics) may be determined and/or utilized to characterize and/or categorize the player via a game play style attribute. In some embodiments, game play style attributes may be quantitative and/or may define one or more ranges of quantitative values. A first game play style attribute (“A1”) may, for example, be defined by the following formula:

$$A 1 = \frac{B + R}{F} \qquad ( 1 )$$

where “B” is a number of bets/wagers, “R” is a number of raises, and “F” is a number of folds.

The number of bets plus raises (“B”+“R”) as the numerator and the number of folds (“F”) as the denominator may comprise the first game play style attribute, for example. In some embodiments, the first game play style attribute may comprise two or more ranges based on the formula (1). For example, a first range of values for the first game play style attribute (“A1”) may be categorized as and/or described by a first qualitative descriptor (e.g., “Level 1”) and a second range of values for the first game play style attribute (“A1”) may be categorized as and/or described by a second qualitative descriptor (e.g., “Level 2”).

According to some embodiments, a second game play style attribute (“A2”) may be defined by the following formula:

$$A 2 = \frac{B + R}{C + F} \qquad ( 2 )$$

where “C” is a number of calls.

The number of bets plus raises (“B”+“R”) as the numerator and the number of calls plus folds (“C”+“F”) as the denominator may comprise the second game play style attribute, for example.

In some embodiments, a third game play style attribute (“A3”), e.g. a “game play aggressiveness attribute”, may be defined by the following formula:

$$A 3 = \frac{P F R}{V P I P} \qquad ( 3 )$$

where “PFR” is a number of pre-flop raises and “VPIP” is an amount of voluntary pay-in-pot.

The game play aggressiveness attribute may be calculated and/or utilized as an allocation driver. How aggressive a player plays may be quantified, in accordance with equation (3) for example, as the number of PFR over VPIP.

According to some embodiments, the players 630 may be allocated to the slots 632 based on attributes specifically desired for the slots 632. It may be determined, for example, that the first slot 632-1 should be filled with a player 630 from a certain geographic area (e.g., an area far from—e.g., greater than a predetermine distance from—a geographic area of the seventh player 630-7) and the second slot 632-2 should be filled with a player 630 having a certain profession. In the case that the second player 630-2 is determined to be from the (or a) desired geographic area, it may be determined that it is desirable to move the second player 630-2 to the first slot 632-1. In the case that the fifth player 630-5 is determined to be of the desired profession, it may be determined that it is desirable to move the fifth player 630-5 to the second slot 632-2. Other attributes that may also or alternatively be utilized may comprise (but are not limited to), for example, game play style metrics and/or attributes, game play aggressiveness attributes and/or metrics, monetary and/or account information (e.g., credit balance), etc. According to some embodiments, players may be allocated based not on like attributes, but on disparity of attributes and/or attribute values. It may be determined, for example, that game play is likely to be more entertaining in the case that players of varying attributes (e.g., game styles and/or aggressiveness levels) play together (e.g., even despite varying skill levels). While it may be desirable in some embodiments to group players having similar educational backgrounds or similar or complimentary professions together, for example, in other embodiments it may be desirable to group players with disparate and/or differing educational backgrounds and/or professions. Some (non-limiting) examples of different player attribute mixes that may be desirable for a particular game session/room are listed in the following table:

TABLE 1
Example player attribute mixes.

| Attributes | Player #1 | Player #2 | Player #3 | Player #4 |
|---|---|---|---|---|
| Similar Professions | Lawyer | Lawyer | Lawyer | Paralegal |
| Differing Professions | Doctor | Truck Driver | Banker | Waitress |
| Similar Raise | Low | Medium | Low | Medium |
| variability | variability | variability | variability | variability |
| Differing Raise | Low | High | No data | Extremely |
| variability | variability | variability | | high |
| | | | | variability |
| Player “chatter” | 86 | 23 | 0 | 47 |
| mix ‘A’ | | | | |
| (chatter scores) | | | | |
| Player “chatter” | 95 | 90 | 94 | 97 |
| mix ‘B’ | | | | |
| (chatter scores) | | | | |
| Similar | Level A | Level A | Level A | Level A |
| aggressiveness | | | | |
| Differing | Low | Middle | High | High |
| aggressiveness | | | | |
| Similar Geo | London | London | London | London |
| Differing Geo | United | Canada | Mali | China |
| | Kingdom | | | |

In some embodiments, one or more of the game attributes 622a-c may be altered in response to a determination that it is desirable to move one or more players 630. The first game attribute 622a of the first game instance 620a may, for example, be made less desirable to the second player 630-2 (e.g., based on knowledge of preferences of the second player 630-2) and/or the third game attribute 622c of the third game instance 620c may be made more desirable. A buy-in amount, minimum or maximum wager amount, number of available player positions, payout structure, odds, and/or other game variables may, for example, be altered and/or set to either be in conformance with a derived or stored player preference regarding such variables or may be altered and/or set to specifically not be in accordance with derived or stored acceptable ranges for such variables. In some embodiments, players 630 may be placed in the lobby 610 before being reallocated (e.g., as desired by the system 600). In some embodiments, players 630 may be reallocated directly to one or more desired slots 632.

In some embodiments, one or more of the game instances 620a-b may comprise and/or be associated with one or more player attribute scoring thresholds. In the case of any particular attribute or class of attributes, for example, a minimum, maximum, and/or target scoring threshold may be established. In some embodiments, the scoring threshold may comprise a minimum ‘chat’ score (e.g., a measure of player propensity for text or verbal discourse in association with an online game) desired for a particular game instance 620a-b. The desired ‘chat’ score of fifty (50), for example, may be obtained by summing individual; ‘chat’ scores for players 630 assigned to (or considered for assignment to) the particular game instance 620a-b. According to some embodiments, such a threshold may be utilized to drive, inform, and/or determine player allocations. In the case of an aggressiveness attribute or score threshold, for example, it may be desirable to limit an aggressiveness for a game session 620a-b to a certain predefined level (e.g., defined prior to game play initiation and/or establishment of the game session 620a-b). In such an embodiments, in the case that a particular player 630 is being considered for allocation, the player's aggressiveness score may be compared to the session threshold to determine if placement of the player 630 in the game instance 630a-b would cause the threshold to be exceeded. In some embodiments, in the case that the threshold would be exceeded by adding the player 630 to the instance, the player 630 may be assigned/allocated to a different instance 620a-b.

Referring now to FIG. 7, a flow diagram of a method 700 according to some embodiments is shown. In some embodiments, the method 700 may be performed and/or implemented by and/or otherwise associated with one or more specialized and/or computerized processing devices (e.g., the player and/or user devices 102a-n, 202a-n, 302a-b, 402, 502 and/or the servers and/or controller devices 110, 210a-n, 310a-g, 410e-f, 510a-j of FIG. 1, FIG. 2, FIG. 3, FIG. 4, and/or FIG. 5 herein), specialized computers, computer terminals, computer servers, computer systems and/or networks, and/or any combinations thereof (e.g., by one or more online gaming company and/or online gaming player processing devices). In some embodiments, the method 700 may be embodied in, facilitated by, and/or otherwise associated with various input mechanisms and/or interfaces. In some embodiments, the method 700 may be implemented in conjunction and/or association with the system 600 of FIG. 6.

The process and/or flow diagrams described herein do not necessarily imply a fixed order to any depicted actions, steps, and/or procedures, and embodiments may generally be performed in any order that is practicable unless otherwise and specifically noted. Any of the processes and/or methods described herein may be performed and/or facilitated by hardware, software (including microcode), firmware, or any combination thereof. For example, a storage medium (e.g., a hard disk, Universal Serial Bus (USB) mass storage device, and/or Digital Video Disk (DVD)) may store thereon instructions that when executed by a machine (such as a computerized processing device) result in performance according to any one or more of the embodiments described herein.

In some embodiments, the method 700 may comprise determining a first player that desires to play an online game, at 702. The first player may, for example, visit an online gaming website, initiate a mobile gaming application, and/or otherwise login to or express interest in a particular online game, online gaming provider, and/or online gaming session or instance. In some embodiments, the first player may login to a player account and/or utilize an interface to select a particular online and/or multiplayer game and/or game session. In some embodiments, the determining may comprise receiving an indication of a first player identifier assigned to the first player (e.g., from a mobile device of the first player).

According to some embodiments, the method 700 may comprise determining a game play style metric (and/or attribute) of first player, at 704. Information stored in association with the first player may, for example, be utilized to calculate, lookup, infer, and/or otherwise determine one or more play style metrics and/or attributes associated with the first player. Previous game play information descriptive of the first player may be determined, for example, based on identifying information of the first player such as the first player's name, address, phone number, e-mail address, screen name or handle, and/or other identifier (e.g., player identifier, credit card identifier, drivers' license number, etc.). In the case that the first player has played online or multiplayer games previously (e.g., with the same gaming entity), the first player's gaming history may be analyzed and/or utilized to determine one or more game play style metrics and/or attributes. Previous game play by the first player may be utilized to calculate, predict, infer, and/or otherwise determine, for example, a level of aggressiveness of the first player, a propensity of the first player to engage socially (e.g., chat) while playing (and/or between game sessions—e.g., in the game lobby), and/or a volatility measure of the first player's previous game play.

In some embodiments, the method 700 may comprise determining, based on the game play style metric of the first player, an instance of the game in which to place the first player, at 706. Certain game rooms or tables (e.g., virtual), sessions, and/or instances may, for example, comprise and/or be associated with different requirements and/or goals (e.g., thresholds) with respect to game play style attributes and/or metrics of players therein. Some rooms may require a certain level of aggressiveness (or lack thereof) to gain entry thereto, for example, while other rooms may have a maximum aggressiveness threshold that the sum of all aggressiveness metrics for room players must fall below. In some cases, rooms and/or players may comprise requirements (or preferences) regarding compatibility of players. It may be determined, for example, that (e.g., for a particular game instance) two players having similar VPIP metrics should not be (or should be) placed together. Thus, in some embodiments, the first player's game play style metric may be compared to game session requirements to determine if the player is allowed to (or should) be placed in a particular room. In some embodiments, the first player's game play attribute may be compared to attributes/metrics of other players already assigned to the room (or being considered for assignment to the room) to determine compatibility between the players—e.g., whether they should be placed in the same game session together. In some embodiments, the first player's attribute/metric may be considered in combination with attributes/metrics of other players to determine an overall player mix for a particular room (e.g., with respect to desired or acceptable minimums, maximums, averages, means, and/or ranges of attribute/metric values). In some embodiments, such as in the case that multiple available game sessions/instances are determined to be acceptable, the selected instance may be determined randomly from the acceptable sessions or the different sessions may be scored or ranked and the highest scoring or ranking session may be selected.

According to some embodiments, the method 700 may comprise assigning the first player to the determined instance of the game, at 708. In response to the first player requesting a particular game instance assignment, for example, and upon determining that such a game instance is an acceptable destination for the first player, a gaming system may assign or place the first player into the selected game session. In some embodiments, such as in the case that the first player (and/or other players) are automatically assigned to specific game sessions, the first player may not be made aware of the availability of other sessions not selected. In such embodiments, upon logging into the gaming system, the first player may simply be assigned to the selected game session.

Referring now to FIG. 8, a flow diagram of a method 800 according to some embodiments is shown. In some embodiments, the method 800 may be performed and/or implemented by and/or otherwise associated with one or more specialized and/or computerized processing devices (e.g., the player and/or user devices 102a-n, 202a-n, 302a-b, 402, 502 and/or the servers and/or controller devices 110, 210a-n, 310a-g, 410e-f, 510a-j of FIG. 1, FIG. 2, FIG. 3, FIG. 4, and/or FIG. 5 herein), specialized computers, computer terminals, computer servers, computer systems and/or networks, and/or any combinations thereof (e.g., by one or more online gaming company and/or online gaming player processing devices). In some embodiments, the method 800 may be embodied in, facilitated by, and/or otherwise associated with various input mechanisms and/or interfaces. In some embodiments, the method 800 may be implemented in conjunction and/or association with the system 600 of FIG. 6.

In some embodiments, the method 800 may comprise determining a first player that desires to play a game, at 802. The first player may, for example, visit an online gaming website, initiate a mobile gaming application, and/or otherwise login to or express interest in a particular online game, online gaming provider, and/or online gaming session or instance. In some embodiments, the first player may login to a player account and/or utilize an interface to select a particular online and/or multiplayer game and/or game session. In some embodiments, the determining may comprise receiving an indication of a first player identifier assigned to the first player (e.g., from a mobile device of the first player).

According to some embodiments, the method 800 may comprise determining an attribute of the first player, at 804. Information stored in association with the first player may, for example, be utilized to calculate, lookup, infer, and/or otherwise determine one or more attributes (such as play style metrics) and/or metrics associated with the first player. Demographic and/or geographic information of the first player may be determined, for example, based on identifying information of the first player such as the first player's name, address, phone number, e-mail address, screen name or handle, and/or other identifier (e.g., player identifier, credit card identifier, drivers' license number, etc.). In the case that the first player has played online or multiplayer games previously (e.g., with the same gaming entity), the first player's gaming history may be analyzed and/or utilized to determine one or more game play style metrics and/or attributes.

In some embodiments, the method 800 may comprise determining an entertainment matrix for an instance of the game, at 806. A particular game instance may, for example, be assigned a particular desired threshold, matrix, or range with respect to one or more player attributes—i.e., a desired level and/or mix of attributes with respect to all players assigned to the session. In some embodiments, the matrix may be established to increase entertainment value for the game session. While typical player allocation algorithms may take into account player skill in determining session gating or assignments, for example, some present embodiments may employ the entertainment matrix to increase player enjoyment irrespective of skill levels. According to some embodiments, the matrix may comprise a listing of desired attributes and/or number of players desired there for, as illustrated for exemplary and non-limiting purposes in the following table:

TABLE 2
Example Player Attribute Quantity Matrix.

| Attribute | # of Players |
|---|---|
| From London | 3 |
| From New York | 3 |
| College Degree | 5 |
| High Aggressiveness | 0 |
| Medium Aggressiveness | 4 |
| Low Aggressiveness | 2 |

According to some embodiments, the matrix may comprise a more detailed indication of a mix of attributes desired for particular player slots in the game session, as exemplified by the following table:

TABLE 3
Example Player Attribute Allocation Matrix.

| Metric | Player #1 | Player #2 | Player #3 |
|---|---|---|---|
| Volatility > 5 | X | | X |
| Low VPIP | X | X | |
| Aggressiveness < 267 | | X | |
| ISP within 100 miles of major city | | | X |
| Loss Limit > $500 | X | X | X |

According to some embodiments, the method 800 may comprise determining that the attribute of the first player corresponds to the entertainment matrix, at 808. The first player's attribute may be compared to game session requirements to determine if the player is allowed to (or should) be placed in a particular room. In some embodiments, the first player's attribute may be compared to attributes/metrics of other players already assigned to the room (or being considered for assignment to the room) to determine compatibility between the players—e.g., whether they should be placed in the same game session together. In some embodiments, the first player's attribute/metric may be considered in combination with attributes/metrics of other players to determine an overall player mix for a particular room (e.g., with respect to desired or acceptable minimums, maximums, averages, means, and/or ranges of attribute/metric values). In some embodiments, several attributes and/or metrics may be analyzed or considered to determine if the first player is a “good fit” for the game session—e.g., based on the entertainment matrix.

In some embodiments, the method 800 may comprise assigning the first player to the instance of the game, at 810. In response to the first player requesting a particular game instance assignment, for example, and upon determining that such a game instance is an acceptable destination for the first player, a gaming system may assign or place the first player into the selected game session. In some embodiments, such as in the case that the first player (and/or other players) are automatically assigned to specific game sessions, the first player may not be made aware of the availability of other sessions not selected. In such embodiments, upon logging into the gaming system, the first player may simply be assigned to the selected game session.

Referring now to FIG. 9, a flow diagram of a method 900 according to some embodiments is shown. In some embodiments, the method 900 may be performed and/or implemented by and/or otherwise associated with one or more specialized and/or computerized processing devices (e.g., the player and/or user devices 102a-n, 202a-n, 302a-b, 402, 502 and/or the servers and/or controller devices 110, 210a-n, 310a-g, 410e-f, 510a-j of FIG. 1, FIG. 2, FIG. 3, FIG. 4, and/or FIG. 5 herein), specialized computers, computer terminals, computer servers, computer systems and/or networks, and/or any combinations thereof (e.g., by one or more online gaming company and/or online gaming player processing devices). In some embodiments, the method 900 may be embodied in, facilitated by, and/or otherwise associated with various input mechanisms and/or interfaces. In some embodiments, the method 900 may be implemented in conjunction and/or association with the system 600 of FIG. 6.

In some embodiments, the method 900 may comprise determining a desired mix of player attributes for slots of a first instance of a game, at 902. As described herein, for example, various thresholds, maximums, minimums, averages, means, matrices, and/or particular attribute combinations may be desired (or desired to be avoided) for particular game sessions. The desired mix may be stored and/or available to back-end systems such as via one more database records and/or tables identifying the desired mix. In some embodiments, the desired mix may be represented and/or provided via a front-end interface. Players may be made aware, for example, of game sessions designated for particular geographic players, for players having similar interests (e.g., fans of the same sports team), for players desiring highly volatile player, etc.

According to some embodiments, the method 900 may comprise determining that a player of a second instance of the game has a player attribute that corresponds to one of the desired attributes, at 904. When trying to fill players in the first game instance, for example, players desiring to join the first game instance, players in a game lobby, and/or players in other game instances (such as the second game instance) may be considered and/or evaluated. In some embodiments, unassigned players (e.g., players in the game lobby) may be analyzed first while players from other game instances may only be analyzed if the desired mix cannot be achieved with only unassigned players (e.g., within a certain threshold time such as two (2) minutes).

In some embodiments, the method 900 may comprise altering a game setting of the second instance of the game, at 906. Once the player from the second game instance has been identified as being desirable for assignment to the first game instance, steps may be taken to incentivize the player to leave the second game instance and/or join the first game instance. According to some embodiments, the game setting of the second game instance (i.e., the instance in which the player is currently assigned) may be altered to make the second game instance less desirable to the player (and/or to other players in the second game instance). The second game instance may be altered, for example, be changing minimum and/or maximum wager amounts, changing the type of game (and/or mode) played in the second session (e.g., changing the type of poker game or even changing to a different type of wagering or online game altogether, such as changing from a poker game to a slots game). In the case that information descriptive of preferences of the player is known, the game setting may be altered to not be in conformance with one or more such preferences (e.g., making the second game session less desirable to the player specifically). In some embodiments, the player may also or alternatively be provided an incentive such as a free amount of credits, better odds, special game skills or items, etc. if the player agrees to an active reassignment from the second game session to the second game session. In some embodiments, the altering of the setting may comprise causing an end of the second instance of the game—e.g., after a certain amount of time, such as ten (10) seconds or five (5) minutes; either made know to the players or not.

According to some embodiments, the method 900 may comprise determining that the player has left the second instance of the game, at 908. Activities and/or allocations of the player may be monitored, for example, to determine if and/or when the player leaves the second game instance. In some embodiments, such as in the case that the player is actively reassigned (e.g., with knowledge of the reassignment), the determining may comprise a receipt of an indication from the player that the player consents to reassignment.

In some embodiments, the method 900 may comprise assigning the player to one of the slots of the first instance of the game, at 910. Once the desired player is known to be available (e.g., either willing to leave the second instance or already in the lobby) the player may be assigned/allocated to the first instance. The lobby shown to the player may be altered, in some embodiments, to prioritize the first instance so that the player is more likely to join the first instance, or even to only show the first instance (effectively forcing the player to play in the first instance if the player desired to continue play). According to some embodiments, the player may be automatically assigned to the first game instance without input from the player.

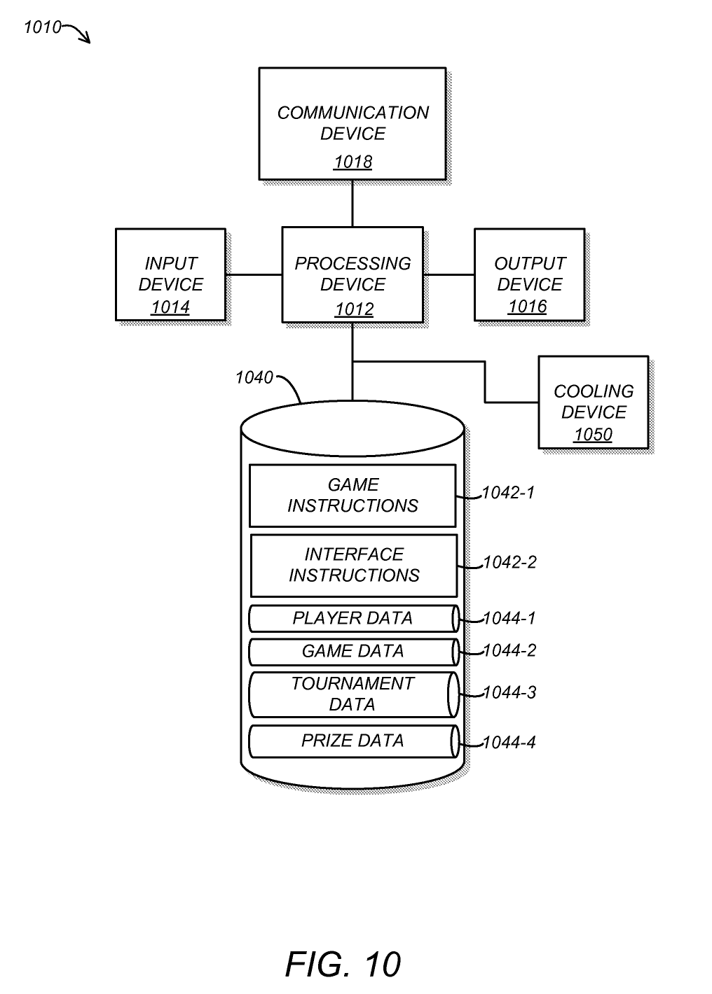

Turning to FIG. 10, a block diagram of an apparatus 1000 according to some embodiments is shown. In some embodiments, the apparatus 1000 may be similar in configuration and/or functionality to any of the player and/or user devices 102a-n, 202a-n, 302a-b, 402, 502 and/or the servers and/or controller devices 110, 210a-n, 310a-g, 410e-f, 510a-j of FIG. 1, FIG. 2, FIG. 3, FIG. 4, and/or FIG. 5 herein, and/or may otherwise comprise a portion of the systems 100, 200, 300, 400, 500 of FIG. 1, FIG. 2, FIG. 3, FIG. 4, and/or FIG. 5 herein. The apparatus 1000 may, for example, execute, process, facilitate, and/or otherwise be associated with the methods 800, 900 described in conjunction with FIG. 8 and/or FIG. 9 herein. In some embodiments, the apparatus 1000 may comprise a processing device 1012, an input device 1014, an output device 1016, a communication device 1018, a memory device 1040, and/or a cooling device 1050. According to some embodiments, any or all of the components 1012, 1014, 1016, 1018, 1040, 1050 of the apparatus 1000 may be similar in configuration and/or functionality to any similarly named and/or numbered components described herein. Fewer or more components 1012, 1014, 1016, 1018, 1040, 1050 and/or various configurations of the components 1012, 1014, 1016, 1018, 1040, 1050 be included in the apparatus 1000 without deviating from the scope of embodiments described herein.

According to some embodiments, the processing device 1012 may be or include any type, quantity, and/or configuration of electronic and/or computerized processor that is or becomes known. The processing device 1012 may comprise, for example, an Intel® IXP 2800 network processor or an Intel® XEON™ Processor coupled with an Intel® E7501 chipset. In some embodiments, the processing device 1012 may comprise multiple inter-connected processors, microprocessors, and/or micro-engines. According to some embodiments, the processing device 1012 (and/or the apparatus 1000 and/or portions thereof) may be supplied power via a power supply (not shown) such as a battery, an Alternating Current (AC) source, a Direct Current (DC) source, an AC/DC adapter, solar cells, and/or an inertial generator. In the case that the apparatus 1000 comprises a server such as a blade server, necessary power may be supplied via a standard AC outlet, power strip, surge protector, a PDU, and/or Uninterruptible Power Supply (UPS) device.

In some embodiments, the input device 1014 and/or the output device 1016 are communicatively coupled to the processing device 1012 (e.g., via wired and/or wireless connections and/or pathways) and they may generally comprise any types or configurations of input and output components and/or devices that are or become known, respectively. The input device 1014 may comprise, for example, a keyboard that allows an operator of the apparatus 1000 to interface with the apparatus 1000 (e.g., by a player, such as to participate in an online game session as described herein). In some embodiments, the input device 1014 may comprise a sensor configured to provide information such as player relationships to the apparatus 1000 and/or the processing device 1012. The output device 1016 may, according to some embodiments, comprise a display screen and/or other practicable output component and/or device. The output device 1016 may, for example, provide a game interface (not explicitly shown in FIG. 10) to a player (e.g., via a website). According to some embodiments, the input device 1014 and/or the output device 1016 may comprise and/or be embodied in a single device such as a touch-screen monitor.

In some embodiments, the communication device 1018 may comprise any type or configuration of communication device that is or becomes known or practicable. The communication device 1018 may, for example, comprise a network interface card (NIC), a telephonic device, a cellular network device, a router, a hub, a modem, and/or a communications port or cable. In some embodiments, the communication device 1018 may be coupled to provide data to a player device (not shown in FIG. 10), such as in the case that the apparatus 1000 is utilized to provide a game interface to a player as described herein. The communication device 1018 may, for example, comprise a cellular telephone network transmission device that sends signals indicative of game interface components to customer and/or subscriber handheld, mobile, and/or telephone device. According to some embodiments, the communication device 1018 may also or alternatively be coupled to the processing device 1012. In some embodiments, the communication device 1018 may comprise an IR, RF, Bluetooth™, and/or Wi-Fi® network device coupled to facilitate communications between the processing device 1012 and another device (such as a player device and/or a third-party device).

The memory device 1040 may comprise any appropriate information storage device that is or becomes known or available, including, but not limited to, units and/or combinations of magnetic storage devices (e.g., a hard disk drive), optical storage devices, and/or semiconductor memory devices such as RAM devices, Read Only Memory (ROM) devices, Single Data Rate Random Access Memory (SDR-RAM), Double Data Rate Random Access Memory (DDR-RAM), and/or Programmable Read Only Memory (PROM). The memory device 1040 may, according to some embodiments, store one or more of game instructions 1042-1 and/or interface instructions 1042-2. In some embodiments, the game instructions 1042-1 and/or the interface instructions 1042-2 may be utilized by the processing device 1012 to provide output information via the output device 1016 and/or the communication device 1018.

According to some embodiments, the game instructions 1042-1 may be operable to cause the processing device 1012 to process player data 1044-1, game data 1044-2, tournament data 1044-3, and/or prize data 1044-4. Player data 1044-1, game data 1044-2, tournament data 1044-3, and/or prize data 1044-4 received via the input device 1014 and/or the communication device 1018 may, for example, be analyzed, sorted, filtered, decoded, decompressed, ranked, scored, plotted, and/or otherwise processed by the processing device 1012 in accordance with the game instructions 1042-1. In some embodiments, player data 1044-1, game data 1044-2, tournament data 1044-3, and/or prize data 1044-4 may be fed by the processing device 1012 through one or more mathematical and/or statistical formulas and/or models in accordance with the game instructions 1042-1 to provide online game sessions and/or allocate players amongst such session, in accordance with embodiments described herein.

In some embodiments, the interface instructions 1042-2 may be operable to cause the processing device 1012 to process player data 1044-1, game data 1044-2, tournament data 1044-3, and/or prize data 1044-4. Player data 1044-1, game data 1044-2, tournament data 1044-3, and/or prize data 1044-4 received via the input device 1014 and/or the communication device 1018 may, for example, be analyzed, sorted, filtered, decoded, decompressed, ranked, scored, plotted, and/or otherwise processed by the processing device 1012 in accordance with the interface instructions 1042-2. In some embodiments, player data 1044-1, game data 1044-2, tournament data 1044-3, and/or prize data 1044-4 may be fed by the processing device 1012 through one or more mathematical and/or statistical formulas and/or models in accordance with the interface instructions 1042-2 to provide one or more game interfaces such as to provide a player lobby, a plurality of game sessions/instances, and/or allocate players thereto, in accordance with embodiments described herein.

Any or all of the exemplary instructions and data types described herein and other practicable types of data may be stored in any number, type, and/or configuration of memory devices that is or becomes known. The memory device 1040 may, for example, comprise one or more data tables or files, databases, table spaces, registers, and/or other storage structures. In some embodiments, multiple databases and/or storage structures (and/or multiple memory devices 1040) may be utilized to store information associated with the apparatus 1000. According to some embodiments, the memory device 1040 may be incorporated into and/or otherwise coupled to the apparatus 1000 (e.g., as shown) or may simply be accessible to the apparatus 1000 (e.g., externally located and/or situated).

In some embodiments, the apparatus 1000 may comprise a cooling device 1050. According to some embodiments, the cooling device 1050 may be coupled (physically, thermally, and/or electrically) to the processing device 1012 and/or to the memory device 1040. The cooling device 1050 may, for example, comprise a fan, heat sink, heat pipe, radiator, cold plate, and/or other cooling component or device or combinations thereof, configured to remove heat from portions or components of the apparatus 1000.

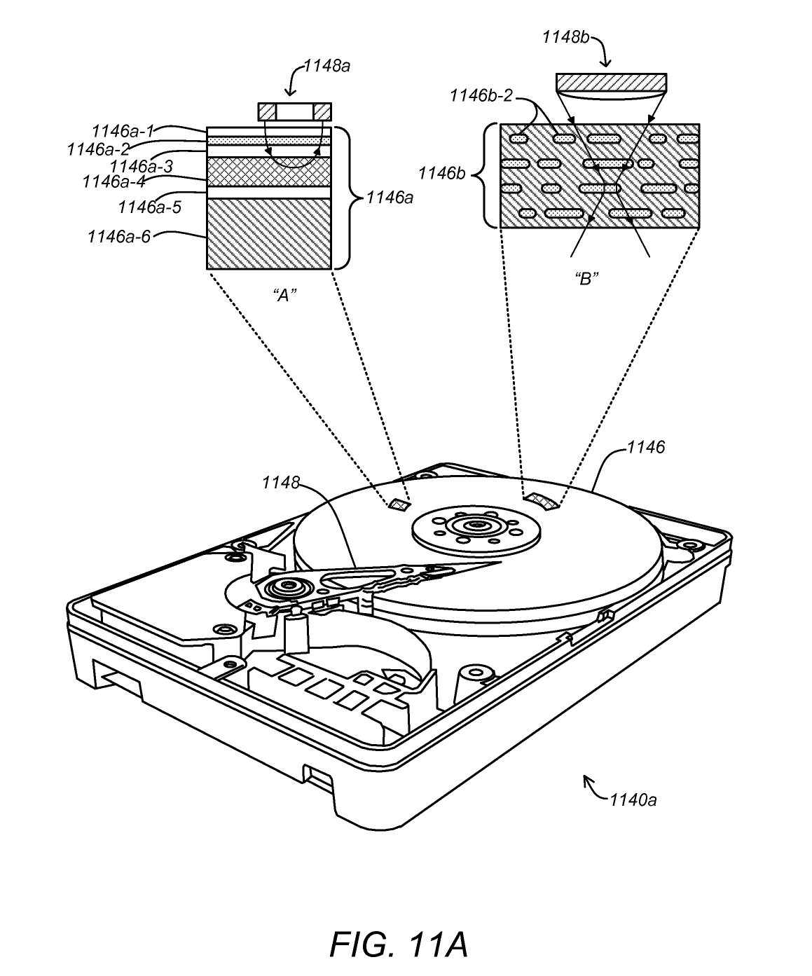

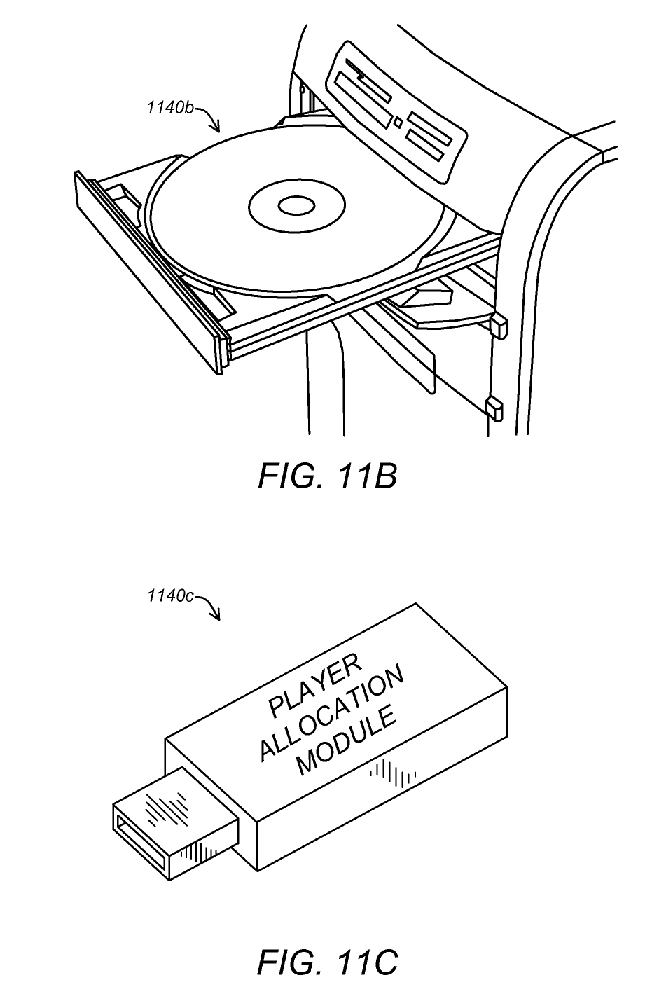

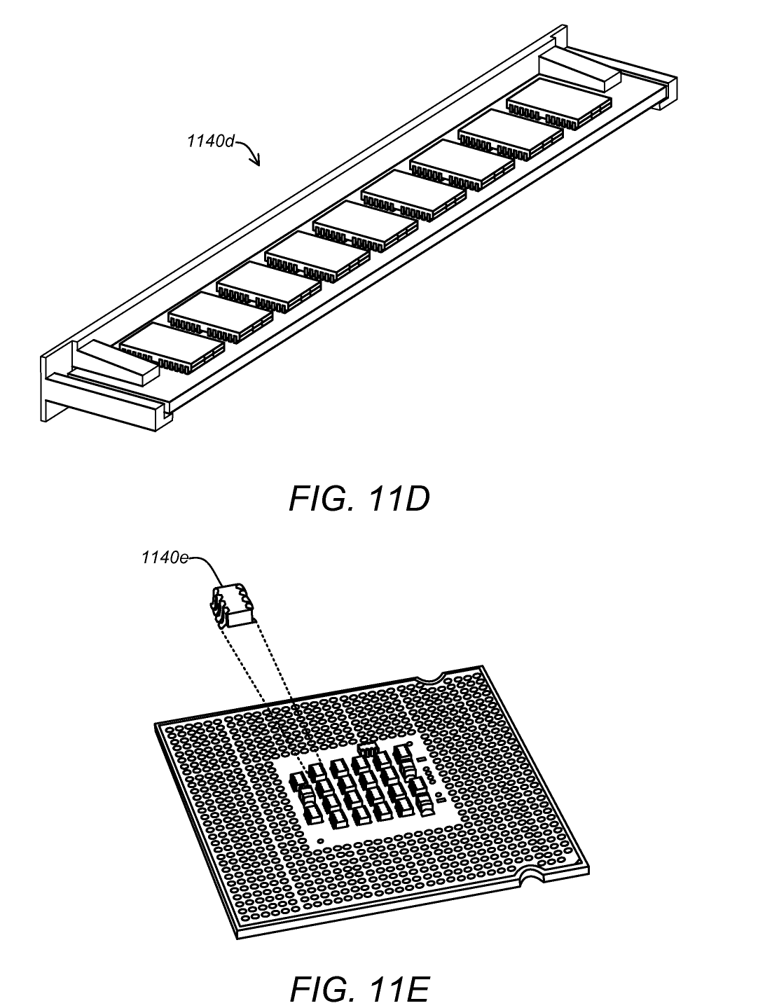

Referring to FIG. 11A, FIG. 11B, FIG. 11C, FIG. 11D, and FIG. 11E, perspective diagrams of exemplary data storage devices 1140a-e according to some embodiments are shown. The data storage devices 1140a-d may, for example, be utilized to store instructions and/or data such as the game instructions 1042-1 and/or interface instructions 1042-2, each of which is described in reference to FIG. 10 herein. In some embodiments, instructions stored on the data storage devices 1140a-d may, when executed by a processor (such as the processor device 1012 of FIG. 10), cause the implementation of and/or facilitate the methods 700, 800, 900 described in conjunction with FIG. 7, FIG. 8 and/or FIG. 9, and/or portions or combinations thereof, as described herein.

According to some embodiments, the first data storage device 1140a may comprise one or more various types of internal and/or external hard drives. The first data storage device 1140a may, for example, comprise a data storage medium 1146 that is read, interrogated, and/or otherwise communicatively coupled to and/or via a disk reading device 1148. In some embodiments, the first data storage device 1140a and/or the data storage medium 1146 may be configured to store information utilizing one or more magnetic, inductive, and/or optical means (e.g., magnetic, inductive, and/or optical-encoding). The data storage medium 1146, depicted as a first data storage medium 1146a for example (e.g., breakout cross-section “A”), may comprise one or more of a polymer layer 1146a-1, a magnetic data storage layer 1146a-2, a non-magnetic layer 1146a-3, a magnetic base layer 1146a-4, a contact layer 1146a-5, and/or a substrate layer 1146a-6. According to some embodiments, a magnetic read head 1146a may be coupled and/or disposed to read data from the magnetic data storage layer 1146a-2.

In some embodiments, the data storage medium 1146, depicted as a second data storage medium 1146b for example (e.g., breakout cross-section “B”), may comprise a plurality of data points 1146b-2 disposed with the second data storage medium 1146b. The data points 1146b-2 may, in some embodiments, be read and/or otherwise interfaced with via a laser-enabled read head 1148b disposed and/or coupled to direct a laser beam through the second data storage medium 1146b.

In some embodiments, the second data storage device 1140b may comprise a CD, CD-ROM, DVD, Blu-Ray™ Disc, and/or other type of optically-encoded disk and/or other storage medium that is or becomes know or practicable. In some embodiments, the third data storage device 1140c may comprise a USB keyfob, dongle, and/or other type of flash memory data storage device that is or becomes know or practicable. In some embodiments, the fourth data storage device 1140d may comprise RAM of any type, quantity, and/or configuration that is or becomes practicable and/or desirable. In some embodiments, the fourth data storage device 1140d may comprise an off-chip cache such as a Level 2 (L2) cache memory device. According to some embodiments, the fifth data storage device 1140e may comprise an on-chip memory device such as a Level 1 (L1) cache memory device.

The data storage devices 1140a-e may generally store program instructions, code, and/or modules that, when executed by a processing device cause a particular machine to function in accordance with one or more embodiments described herein. The data storage devices 1140a-e depicted in FIG. 11A, FIG. 11B, FIG. 11C, FIG. 11D, and FIG. 11E are representative of a class and/or subset of computer-readable media that are defined herein as “computer-readable memory” (e.g., non-transitory memory devices as opposed to transmission devices or media).

The terms “computer-readable medium” and “computer-readable memory” refer to any medium that participates in providing data (e.g., instructions) that may be read by a computer and/or a processor. Such a medium may take many forms, including but not limited to non-volatile media, volatile media, and other specific types of transmission media. Non-volatile media include, for example, optical or magnetic disks and other persistent memory. Volatile media include DRAM, which typically constitutes the main memory. Other types of transmission media include coaxial cables, copper wire, and fiber optics, including the wires that comprise a system bus coupled to the processor.

Common forms of computer-readable media include, for example, a floppy disk, a flexible disk, hard disk, magnetic tape, any other magnetic medium, a CD-ROM, Digital Video Disc (DVD), any other optical medium, punch cards, paper tape, any other physical medium with patterns of holes, a RAM, a PROM, an EPROM, a FLASH-EEPROM, a USB memory stick, a dongle, any other memory chip or cartridge, a carrier wave, or any other medium from which a computer can read. The terms “computer-readable medium” and/or “tangible media” specifically exclude signals, waves, and wave forms or other intangible or transitory media that may nevertheless be readable by a computer.

Various forms of computer-readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols. For a more exhaustive list of protocols, the term “network” is defined above and includes many exemplary protocols that are also applicable here.

In some embodiments, one or more specialized machines such as a computerized processing device, a server, a remote terminal, and/or a customer device may implement the various practices described herein. A computer system of an gaming entity may, for example, comprise various specialized computers that interact to provide for online games as described herein

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicants intend to file additional applications to pursue patents for subject matter that has been disclosed and enabled but not claimed in the present application.

What is claimed is:

1. A method, comprising:
determining, by a processing device, that a first player desires to play a multiplayer game;
determining, by the processing device, a game play style metric for the first player, the game play style metric comprising at least one of: (i) an aggressiveness metric defined as a representation of how often the first player conducts a Pre-Flop Raise (PFR); (ii) an aggressiveness metric defined as a representation of how often the first player places Voluntary Pay in Pot (VPiP); and (iii) an aggressiveness metric defined as a ratio of how often the first player conducts a Pre-Flop Raise (PFR) to how often the first player places Voluntary Pay in Pot (VPiP);
determining, by the processing device and based on the game play style metric, an instance of a game in which to place the first player; and
assigning, by the processing device, the first player to the determined instance of the game.

2. The method of claim 1, further comprising:
determining a game play style metric of a second player already assigned to the instance of the game.

3. The method of claim 2, wherein the second player comprises a plurality of players already assigned to the instance of the game.

4. The method of claim 2, wherein the determining of the instance of the game in which to place the first player is further based on the game play style metric of the second player.

5. The method of claim 1, wherein the determining that the first player desires to play the multiplayer game, comprises:
determining that the first player has logged into a virtual lobby of the game.

6. The method of claim 1, wherein in the case that the game play style metric comprises the aggressiveness metric defined as the representation of how often the first player conducts a PFR, the representation of how often the first player conducts a PFR comprises a percentage of occurrences in which the first player conducts a PFR.

7. The method of claim 1, wherein in the case that the game play style metric comprises the aggressiveness metric defined as the representation of how often the first player places VPiP, the representation of how often the first player places VPiP comprises a percentage of occurrences in which the first player places VPiP.

8. The method of claim 1, wherein the instance of the game in which to place the first player comprises one of a plurality of available game instances and wherein the determining of the instance of the game in which to place the first player, comprises:
determining a range of game play style metric values assigned to each game instance of the plurality of available game instances; and
determining that the game play style metric of the first player falls with the range of values assigned to the one of the plurality of available game instances.

9. A method, comprising:
determining, by a processing device, that a first player desires to play a multiplayer game;
determining, by the processing device, an attribute of the first player;
determining, by the processing device, an entertainment matrix desired for an instance of the multiplayer game;
determining, by the processing device, that the attribute of the first player corresponds to the entertainment matrix desired for the instance of the multiplayer game; and
assigning, by the processing device and based on the determination that the attribute of the first player corresponds to the entertainment matrix desired for the instance of the multiplayer game, the first player to the instance of the game.

10. The method of claim 9, further comprising:
determining, by the processing device, that a second player desires to play the multiplayer game;
determining, by the processing device, an attribute of the second player;
determining, by the processing device, an updated entertainment matrix desired for the instance of the multiplayer game;
determining, by the processing device, that the attribute of the second player fails to correspond to the updated entertainment matrix desired for the instance of the multiplayer game; and
assigning, by the processing device and based on the determination that the attribute of the second player fails to correspond to the updated entertainment matrix desired for the instance of the multiplayer game, the second player to different instance of the multiplayer game.

11. The method of claim 10, wherein the attribute of the first player and the attribute of the second player are the same.

12. The method of claim 10, wherein the updated entertainment matrix desired for the instance of the multiplayer game is determined based at least upon the assignment of the first player to the instance of the multiplayer game.

13. The method of claim 9, wherein the attribute of the first player comprises game play style metric.

14. The method of claim 9, wherein the attribute of the first player comprises a demographic attribute.

15. The method of claim 9, wherein the entertainment matrix desired for the instance of the multiplayer game comprises a predetermined desired allocation of player attributes amongst a plurality of available player slots in the instance of the multiplayer game.

16. A method, comprising:
determining, by a processing device, a desired mix of player attributes for a plurality of player slots of a first instance of an online multiplayer game;
determining, by the processing device, that a player of a second instance of the online multiplayer game has a player attribute that corresponds to one of the desired player attributes for one of the player slots of the plurality of player slots of the first instance of the online multiplayer game;
altering, by the processing device and in response to the determining that the player of the second instance of the online multiplayer game has the player attribute that corresponds to the one of the desired player attributes for the one of the player slots of the plurality of player slots of the first instance of the online multiplayer game, a game setting of the second instance of the online multiplayer game;
determining, by the processing device and after the altering, that the player has left the second instance of the online multiplayer game; and
assigning, by the processing device and after the determining that the player has left the second instance of the online multiplayer game, the player to the one of the player slots of the plurality of player slots of the first instance of the online multiplayer game.

17. The method of claim 16, wherein the altering of the game setting of the second instance of the online multiplayer game, comprises:
increasing a difficulty level of the second instance of the online multiplayer game.

18. The method of claim 16, wherein the altering of the game setting of the second instance of the online multiplayer game, comprises:
increasing a minimum wager amount of the second instance of the online multiplayer game.

19. The method of claim 16, wherein the altering of the game setting of the second instance of the online multiplayer game, comprises:
increasing a difficulty level of the second instance of the online multiplayer game.

20. The method of claim 16, further comprising at least one of:
(i) notifying the player that the altering has occurred; and
(ii) suggesting that the player join the first instance of the online multiplayer game.
